(19) United States
(12) Patent Application Publication
(10) Pub. No.: US 2026/0109864 A1
(43) Pub. Date: Apr. 23, 2026

(54) FLAME RESISTANT COMPOSITIONS FOR ADDITIVE MANUFACTURING AND ASSOCIATED PRINTED 3D ARTICLES COMPRISING ALUMINUM-CONTAINING SPECIES

(71) Applicant: 3D Systems, Inc., Rock Hill, SC (US)

(72) Inventors: Khalil MOUSSA, Rock Hill, SC (US); Mehrgan KHAVARI, Rock Hill, SC (US)

(21) Appl. No.: 19/363,258

(22) Filed: Oct. 20, 2025

Related U.S. Application Data
(60) Provisional application No. 63/709,679, filed on Oct. 21, 2024.

(51) Int. Cl. C09D 4/00; B33Y 70/10; C08K 3/22; C08K 3/32; C09D 5/18; C09D 7/61; C09D 7/63; C09D 133/10; C09D 133/14; C09D 133/16; C09D 135/02; C09D 151/10

(52) U.S. Cl. CPC C09D 4/00; B33Y 70/10; C09D 5/18; C09D 7/61; C09D 7/63; C09D 133/10; C09D 133/14; C09D 133/16; C09D 135/02; C09D 151/10; C08K 2003/2227; C08K 2003/321

(57) ABSTRACT

Compositions and methods for additive manufacturing applications are described herein which, in some embodiments, impart flame resistant and/or flame retardant properties to articles printed or formed from the compositions and methods. In some embodiments, a composition described herein comprises an aluminum-containing species. In some cases, the aluminum-containing species comprises Al(OH)₃. In some instances, the aluminum-containing species comprises a species of Formula I or Formula II described herein.

### CROSS REFERENCE TO RELATED APPLICATIONS

This application claims priority pursuant to 35 U.S.C. § 119 to U.S. Provisional Patent Application No. 63/709,679, filed Oct. 21, 2024, which is hereby incorporated by reference in its entirety.

### FIELD

The present invention relates to compositions and methods for forming three-dimensional (3D) articles, including using 3D printing or additive manufacturing.

### BACKGROUND

Additive manufacturing systems or 3D printers use build materials to form various objects, articles, or parts in accordance with computer generated files. Such materials can include build materials used to form the objects themselves, as compared to sacrificial support materials which may be used to support an object during the additive manufacturing process but which are subsequently removed from the final printed object. Some build materials are also known as inks, for example in the case of polymerizable liquids or other fluids that are jetted or otherwise selectively deposited to form a 3D object. In some such instances, the build material is solid at ambient temperatures and converts to liquid at elevated jetting temperatures. In other instances, the build material is liquid at ambient temperatures. Build materials can also be powders or dry particulate materials, as opposed to polymerizable liquids. Such powders may be used in selective laser sintering (SLS) and similar additive manufacturing techniques.

Compositions for additive manufacturing can comprise a variety of chemical species. Chemical species to include in a build material can be selected according to various considerations including, but not limited to, desired chemical and/or mechanical properties of the printed article and operating parameters of the 3D printing apparatus or system. Unfortunately, some build materials and resultant articles printed from the build materials can be unsuitable for electronics and transportation applications and/or other applications necessitating flame resistance. As a result, 3D printing technology may find limited application in fields requiring flame resistant or flame retardant materials and articles, and there is a need for improved materials for forming flame resistant or flame retardant articles by additive manufacturing.

### SUMMARY

In one aspect, compositions for use with a 3D printer are described herein, which, in some embodiments, may offer one or more advantages over prior materials. Compositions for additive manufacturing applications are described herein which, in some embodiments, impart flame resistant and/or flame retardant properties to articles printed or formed from the compositions. The compositions may, in some cases, also enhance desirable mechanical properties to the articles. In some embodiments, a composition described herein comprises an aluminum-containing species. In some cases, the aluminum-containing species comprises Al(OH)₃. In some instances, the aluminum-containing species comprises a species of Formula I or Formula II:

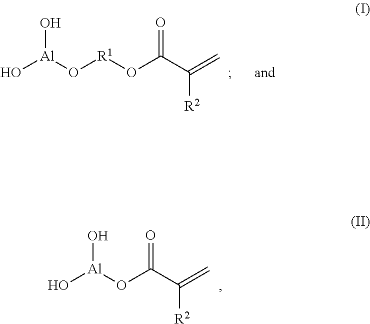

wherein R¹ is a C1-C10 alkyl or alkylene moiety (e.g., CH₂) and R² is H or CH₃.

Moreover, in some embodiments, the aluminum-containing species comprises alumina or Al₂O₃. In some such implementations, the alumina or Al₂O₃ may be functionalized with one or more polymerizable groups. In some cases, for example, the polymerizable group comprises an acrylamide group, a (meth)acrylate group, and/or a vinyl group.

These and other embodiments are described in greater detail in the detailed description which follows.

### BRIEF DESCRIPTION OF THE DRAWINGS

FIG. 1A illustrates a plot of the tensile strength data of a comparative composition and compositions according to some embodiments described herein.

FIG. 1B illustrates a plot of the elongation at break data of a comparative composition and compositions according to some embodiments described herein.

FIG. 1C illustrates a plot of the elastic modulus data of a comparative composition and compositions according to some embodiments described herein.

### DETAILED DESCRIPTION

Embodiments described herein can be understood more readily by reference to the following detailed description and examples. Elements, apparatus and methods described herein, however, are not limited to the specific embodiments presented in the detailed description and examples. It should be recognized that these embodiments are merely illustrative of the principles of the present disclosure. Numerous modifications and adaptations will be readily apparent to those of skill in the art without departing from the spirit and scope of the disclosure.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, 1 to 4, 3 to 7, 4.7 to 10.0, 3.6 to 7.9, or 5 to 8.

All ranges disclosed herein are also to be considered to include the end points of the range, unless expressly stated otherwise. For example, a range of “between 5 and 10,” “from 5 to 10,” or “5-10” should generally be considered to include the end points 5 and 10.

Further, when the phrase “up to” is used in connection with an amount or quantity, it is to be understood that the amount is at least a detectable amount or quantity (that is, the amount is a non-zero amount). For example, a material present in an amount “up to” a specified amount can be present from a detectable (or non-zero) amount and up to and including the specified amount.

It is also to be understood that the article “a” or “an” refers to “at least one,” unless the context of a particular use requires otherwise.

The terms “three-dimensional printing system,” “three-dimensional printer,” “printing,” and the like generally describe various solid freeform fabrication techniques for making three-dimensional articles or objects by stereolithography (SLA), digital light processing (DLP), selective deposition, jetting, fused deposition modeling (FDM), multi-jet modeling (MJM), and other additive manufacturing techniques now known in the art or that may be known in the future that use a build material to fabricate three-dimensional objects.

### I. Compositions for Additive Manufacturing

In one aspect, compositions or build materials for use with a 3D printer or additive manufacturing system are described herein. In some embodiments, a composition described herein comprises an aluminum-containing species. It is to be understood that the aluminum-containing species corresponds to a stable species in which the element aluminum is present. Moreover, it is also to be understood that in such a species, aluminum ionically bonds, covalently bonds, or covalently coordinates with another chemical moiety, chemical species, or ion. In some embodiments, an aluminum-containing species is an aluminum-containing compound, an aluminum-containing complex, or an aluminum-containing salt.

In some cases, the aluminum-containing species comprises Al(OH)₃. In other cases, the aluminum-containing species comprises a species of Formula I or Formula II:

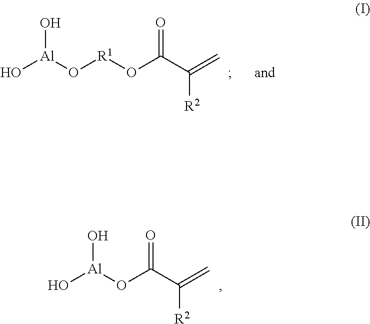

wherein R¹ is a C1-C10 alkyl or alkylene (e.g., CH₂), and R² is H or CH₃.

Additionally, in some implementations, the aluminum-containing species comprises alumina or Al₂O₃. Moreover, in some such embodiments, the alumina or Al₂O₃ may be in the form of a solid, such as a powder or particulate material. Further, in some instances, the alumina or Al₂O₃ (particularly when present as a particulate solid) may have an exterior surface, wherein the exterior surface is functionalized.

In some implementations, for example, alumina or Al₂O₃ may be functionalized with one or more polymerizable groups. A “polymerizable group,” for reference purposes herein, comprises a group or moiety that can be polymerized or cured to provide a printed 3D article or object. Such polymerizing or curing can be carried out in any manner not inconsistent with the objectives of the present disclosure. Polymerizable groups or moieties can comprise those operable to undergo radiation-induced (that is, light-induced) polymerization or non-radiation induced (non-light induced) polymerization. In some cases, alumina or Al₂O₃ may be functionalized with a polymerizable group or moiety bound directly to an aluminum atom. However, in some instances, the polymerizable group may be bound to an oxygen atom of the alumina or Al₂O₃. Moreover, in some implementations, the alumina or Al₂O₃ present in the composition may be only partially functionalized. For example, in some cases, only the surface of alumina or Al₂O₃ may be functionalized with the one or more polymerizable groups.

It is to be understood that the polymerizable group can comprise any polymerizable group not inconsistent with the technical objectives described herein. In some embodiments, the polymerizable group comprises a (meth)acrylamide group. In some implementations, the polymerizable group may comprise a (meth)acrylate. It is to be understood that the term “(meth)acrylate” includes “acrylate” or “methacrylate” or a mixture or combination thereof. Similarly, it is to be understood that the term “(meth)acrylamide” includes “acrylamide” or “methacrylamide” or a mixture or combination thereof. In other embodiments, the polymerizable group may be a vinyl group.

Turning to particular species of functionalized alumina or Al₂O₃, in some implementations, the aluminum-containing species comprises a species of Formula III:

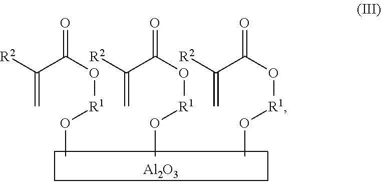

wherein R¹ is C1-C10 alkyl, R² is H or CH₃, and the box containing Al₂O₃ represents the surface of alumina or Al₂O₃, such as the exterior surface of a solid or particulate alumina or Al₂O₃. Moreover, in some embodiments, the aluminum-containing species comprises a species of Formula IV:

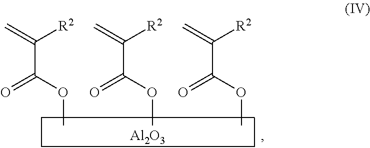

wherein R² is H or CH₃ and the box containing Al₂O₃ represents the surface of alumina or Al₂O₃, such as the exterior surface of a solid or particulate alumina or Al₂O₃. Additionally, in some cases, the aluminum-containing species comprises a species of Formula V:

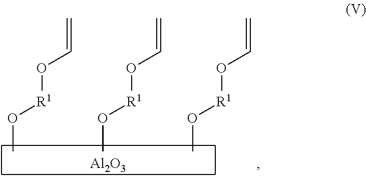

wherein R¹ is C1-C10 alkyl and the box containing Al₂O₃ represents the surface of alumina or Al₂O₃, such as the exterior surface of a solid or particulate alumina or Al₂O₃. Further, in some implementations, the aluminum-containing species comprises a species of Formula VI:

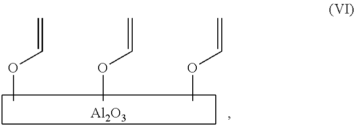

wherein the box containing Al₂O₃ represents the surface of alumina or Al₂O₃, such as the exterior surface of a solid or particulate alumina or Al₂O₃.

Species such as those of Formulas I-VI can be made in a manner understood by those of ordinary skill in the art. For example, reference is made to methods described in one or more of the following: Daimatsu et al., “Preparation and physical properties of flame retardant acrylic resin containing nano-sized aluminum hydroxide,” Polymer Degradation and Stability, vol. 92, issue 8 (August 2007), 1433-1438; and Park et al., “Preparation of Al(OH)₃/Acrylic Copolymer Latex by Emulsion Polymerization,” Composite Interfaces, vol. 17, 2010, pages 505-512.

A composition described herein can include the aluminum-containing species component in any amount not inconsistent with the technical objectives of the present disclosure. For example, in some implementations, the composition may comprise an aluminum-containing species in an amount of up to 20 wt. %, based on the total weight of the composition. Moreover, in some embodiments, the composition may comprise an aluminum-containing species in an amount of up to 18, 16, 14, 12, 10, 8, 6, 4, or 2 wt. %, based on the total weight of the composition. In some embodiments, the aluminum-containing species can be present in an amount of 2-20 wt. %, 2-18 wt. %, 2-16 wt. %, 2-14 wt. %, 2-12 wt. %, 2-10 wt. %, 2-8 wt. %, 2-6 wt. %, 2-4 wt. %, 4-20 wt. %, 4-18 wt. %, 4-16 wt. %, 4-14 wt. %, 4-12 wt. %, 4-10 wt. %, 4-8 wt. %, 4-6 wt. %, 6-20 wt. %, 6-18 wt. %, 6-16 wt. %, 6-14 wt. %, 6-12 wt. %, 6-10 wt. %, 6-8 wt. %, 8-20 wt. %, 8-18 wt. %, 8-16 wt. %, 8-14 wt. %, 8-12 wt. %, 8-10 wt. %, 10-20 wt. %, 6-18 wt. %, 6-16 wt. %, 6-14 wt. %, 6-12 wt. %, 12-20 wt. %, 12-18 wt. %, 12-16 wt. %, 12-14 wt. %, 14-20 wt. %, 14-18 wt. %, 14-16 wt. %, 16-20 wt. %, 16-18 wt. %, or 18-20 wt. %, based on the total weight of the composition.

Additionally, in some instances, a composition described herein further comprises a polymerizable component. Any polymerizable component not inconsistent with the technical objectives of the present disclosure may be used. In some embodiments, the polymerizable component comprises or is a (meth)acrylate component. Again, it is to be understood that the term “(meth)acrylate” includes acrylate or methacrylate or a mixture or combination thereof. In some cases, the (meth)acrylate component comprises a mixture of (meth)acrylate monomer and (meth)acrylate oligomer. As known to the skilled artisan, a monomer is a single structural unit of a polymer or copolymer and is not itself an oligomer or polymer. In contrast, an oligomer comprises a plurality of chemically linked monomers. Moreover, in some cases, a (meth)acrylate “monomer” can comprise or be a relatively low molecular weight species, such as a species having a molecular weight below 300, below 200, or below 100. Similarly, a (meth)acrylate “oligomer” can comprise or be a relatively high molecular weight species, such as a species having a molecular weight above 300, above 400, above 500, or above 600, and optionally below 10,000, where it is understood that the molecular weight may be a weight average molecular weight in the case of an oligomeric species having a molecular weight distribution. In some preferred embodiments, a “monomer” has a molecular weight below 400, and an “oligomer” has a weight average molecular weight above 600. Additionally, in some embodiments, a (meth)acrylate “monomer” has a viscosity of 500 centipoise (cP) or less at 25° C., when measured according to ASTM D2983, while a (meth)acrylate “oligomer” has a viscosity of 1000 cP or more at 25° C., when measured according to ASTM D2983. It is to be understood that the foregoing use of the terms “monomer” and “oligomer” are intended to distinguish between ‘types’ of curable materials or species-those having relatively high molecular weight/viscosity as one ‘type,’ and those having relatively low molecular weight/viscosity as the other ‘type.’ In this context, the terms “monomer” and “oligomer” may both be used to refer to a curable material, particularly a curable material that can undergo polymerization with itself or another species. That is, in this context, either a “monomer” (relatively low molecular weight/viscosity species) or an “oligomer” (relatively high molecular weight/viscosity species) can be a “monomer” in the generic sense of being a chemical species having one or more functional groups or moieties that can react with one another or with another functional group or moiety to form one or more covalent bonds, particularly as part of a polymerization reaction. It is further to be understood that the preceding descriptions of “monomer” versus “oligomer” may be applied to other curable materials that are not (meth)acrylates. That is, in general, a “monomer” component may be distinguished from an “oligomer” component based on the molecular weight and/or viscosity ‘dividing lines’ or ranges described above. The meaning of the terms “monomer,” “monomeric,” “oligomer,” and “oligomeric” in a specific instance or usage will be readily understood by one of ordinary skill in the art based on the context. However, in the event of any ambiguity in a particular instance, the broader meaning of “monomer” or “monomeric” is to be adopted for purposes of the present disclosure. Additionally, for purposes of disclosure of possible embodiments, it is to be understood that any specific use of “monomer” or “monomeric” described herein can be read to possibly refer to a “monomer” or “monomeric” species in the more limited meaning described above (a species having a relatively low molecular weight and/or viscosity).

Further, in some embodiments, the (meth)acrylate component can comprise monofunctional acrylates, difunctional acrylates, or mixtures thereof. In some embodiments, for instance, the (meth)acrylate component comprises methyl (meth)acrylate, ethyl (meth)acrylate, n-propyl (meth)acrylate, n-butyl (meth)acrylate, isobutyl (meth)acrylate, n-hexyl (meth)acrylate, 2-ethylhexyl (meth)acrylate, n-octyl (meth)acrylate, n-decyl (meth)acrylate, n-dodecyl (meth)acrylate, 2-hydroxyethyl (meth)acrylate, 2- or 3-hydroxypropyl (meth)acrylate, 2-methoxyethyl (meth)acrylate, 2-ethoxyethyl (meth)acrylate, 2- or 3-ethoxypropyl (meth)acrylate, tetrahydrofurfuryl methacrylate, isobornyl (meth)acrylate, 2-(2-ethoxyethoxy)ethyl acrylate, cyclohexyl methacrylate, 2-phenoxyethyl acrylate, glycidyl acrylate, isodecyl acrylate, 2-phenoxyethyl (meth)acrylate, lauryl methacrylate, or mixtures thereof. In some embodiments, the (meth)acrylate component comprises a monofunctional or difunctional aliphatic urethane (meth)acrylate, or a monofunctional or difunctional polyether urethane (meth)acrylate.

The (meth)acrylate component, in some embodiments, can comprise one or more of allyl acrylate, allyl methacrylate, triethylene glycol di(meth)acrylate, tricyclodecane dimethanol diacrylate, and cyclohexane dimethanol diacrylate. Additionally, in some embodiments, the (meth)acrylate component comprises diacrylate and/or dimethacrylate esters of aliphatic, cycloaliphatic or aromatic diols, including 1,3- or 1,4-butanediol, neopentyl glycol, 1,6-hexanediol, diethylene glycol, triethylene glycol, tetraethylene glycol, polyethylene glycol, tripropylene glycol, ethoxylated or propoxylated neopentyl glycol, 1,4-dihydroxymethylcyclohexane, 2,2-bis(4-hydroxycyclohexyl) propane or bis(4-hydroxycyclohexyl) methane, hydroquinone, 4,4′-dihydroxybiphenyl, bisphenol A, bisphenol F, bisphenol S, ethoxylated or propoxylated bisphenol A, ethoxylated or propoxylated bisphenol F or ethoxylated or propoxylated bisphenol S.

Additional non-limiting examples of species suitable for inclusion in the (meth)acrylate component comprise the following: isobornyl acrylate (IBOA), commercially available from SARTOMER under the trade name SR 506A; difunctional acrylate commercially available from SARTOMER under the SR 833S trade designation; trifunctional acrylate monomer commercially available from SARTOMER under the SR 533 trade designation; isobornyl methacrylate, commercially available from SARTOMER under the trade name SR 423A; alkoxylated tetrahydrofurfuryl acrylate, commercially available from SARTOMER under the trade name SR 611; monofunctional urethane acrylate, commercially available from RAHN USA under the trade name GENOMER 1122; aliphatic urethane diacrylate, commercially available from ALLNEX under the trade name EBECRYL 8402; difunctional aliphatic urethane (meth)acrylate, commercially available from DYMAX under the BR-952 trade designation; triethylene glycol diacrylate, commercially available from SARTOMER under the trade name SR 272; and triethylene glycol dimethacrylate, commercially available from SARTOMER under the trade name SR 205. Other commercially available curable components may also be used. In addition, in some cases, a monofunctional or difunctional (meth)acrylate comprises an aliphatic polyester urethane acrylate oligomer, a urethane (meth)acrylate resin, and/or an acrylate amine oligomeric resin, such as EBECRYL 7100. In some embodiments, the (meth)acrylate component comprises one or more acrylate derivatives such as acryloylmorpholine.

In addition to the monofunctional and difunctional (meth)acrylate species components described above, it is also possible, in some cases, to include trifunctional or higher functional (meth)acrylate species in a composition described herein. For example, in some instances, one or more tri(meth)acrylates may be used. However, it is to be understood that the functionality (i.e., mono-, di-, tri-, or higher functionality) and the molecular weight of the (meth)acrylate species described herein can be selected to provide a composition having a viscosity suitable for use in a desired 3D printing system. Non-limiting examples of trifunctional or higher (meth)acrylates that may be suitable for use in some embodiments described herein include 1,1-trimethylolpropane tri(meth)acrylate, ethoxylated or propoxylated 1,1,1-trimethylolpropanetri(meth)acrylate, ethoxylated or propoxylated glycerol tri(meth)acrylate, pentaerythritol monohydroxy tri(meth)acrylate, dipentaerythritol monohydroxy penta(meth)acrylate, bis(trimethylolpropane) and tetra(meth)acrylate.

A (meth)acrylate component can be present in a composition described herein in any amount consistent with the objectives described herein. In some embodiments, a (meth)acrylate component can be present in an amount of 30-80 wt. %, 30-70 wt. %, 30-60 wt. %, 30-50 wt. %, 30-40 wt. %, 40-80 wt. %, 40-70 wt. %, 40-60 wt. %, 40-50 wt. %, 50-80 wt. %, 50-70 wt. %, 50-60 wt. %, 60-80 wt. %, 60-70 wt. %, or 70-80 wt. %, based on total weight of the composition.

Moreover, turning to other possible polymerizable components, in some embodiments, the polymerizable component of a composition described herein comprises a chemical species that includes one or more cyclopolymerizable functionalities. For example, in some instances, a polymerizable component of a composition described herein comprises an acrylate moiety and an ethenyl or ethynyl moiety, and the α-carbon of the acrylate moiety and the α-carbon of the ethenyl or ethynyl moiety may have a 1,5-, 1,6-, 1,7-, or 1,8-relationship. In some cases, the cyclopolymerizable monomer may be a monomer having the structure of the following formula:

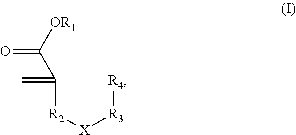

wherein X is O, S, NH, NR₅, or CR₅R₆;
R₁ is H or a hydrocarbon group having 1-10 carbon atoms;
R₂ is a hydrocarbon group having 1-4 carbon atoms;
R₃ is a hydrocarbon group having 1-4 carbon atoms;
R₄ is HC═CH₂ or C≡CH;
R₅ is a hydrocarbon group having 1-4 carbon atoms; and
R₆ is a hydrocarbon group having 1-4 carbon atoms.
   Additionally, the total number of carbon atoms of R₂ and R₃ does not exceed 5. For example, in some instances, a cyclopolymerizable monomer represented by the above formula has the more specific structure of the following formula:

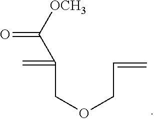

In some embodiments, the polymerizable component of a composition described herein comprises a chemical species that includes one or more cyclopolymerizable functionalities, and the one or more cyclopolymerizable functionalities are separated by an aliphatic linker or alkylene oxide linker. In some instances, the cyclopolymerizable species or functionality is of the following formula:

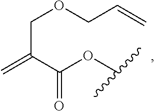 [SMILES: *OC(=O)C(=C)COCC=C]

where [symbol] is an attachment point of the cyclopolymerizable functionality to the linker. In some embodiments, the additive is of Formula VII:

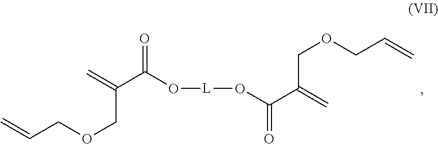

wherein L is the aliphatic or alkylene oxide linker. When present, the alkylene oxide linker can be oligomeric or polymeric, in some embodiments. In such embodiments, the additive can be of Formula VIII:

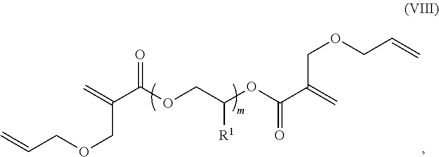

wherein R¹ is hydrogen or alkyl (e.g., C1-C10 alkyl, where a “Cn” alkyl as used herein is understood to include exactly “n” carbon atoms, such that a “C2” alkyl includes exactly 2 carbon atoms and a “C8” alkyl includes exactly 8 carbon atoms, for instance), and m is an integer from 1 to 20. In some embodiments, a cyclopolymerizable species described herein comprises three or more cyclopolymerizable functionalities.

When present, a cyclopolymerizable species can be present in a composition described herein in any amount not inconsistent with the technical objective of the disclosure. In some embodiments, the amount of cyclopolymerizable species is selected according to various considerations including, but not necessarily limited to, desired set of mechanical properties of an article printed from the composition, printing conditions, and/or chemical identity of other species in the composition. In some embodiments, one or more cyclopolymerizable species having a formula described herein are present in a composition in a total amount of 5 to 40 wt. %, 5 to 30 wt. %, 7 to 30 wt. %, or 10 to 30 wt. %., based on total weight of the composition.

A polymerizable component of a composition described herein may include other species, instead of or in addition to the polymerizable species described above. In some embodiments, for example, the polymerizable component comprises a curable isocyanurate component. The curable isocyanurate component can comprise any curable isocyanurate not inconsistent with the technical objectives described herein. In some embodiments, the curable isocyanurate comprises one or a mixture of isocyanurate species. Curable isocyanurates comprise at least one moiety or functionality operable to participate in the polymerization process. In some embodiments, the isocyanurate can comprise a plurality of polymerizable moieties or functionalities. As noted above, a “polymerizable moiety,” for reference purposes herein, comprises a moiety that can be polymerized or cured to provide a printed 3D article or object. Such polymerizing or curing can be carried out in any manner not inconsistent with the objectives of the present disclosure. Polymerizable moieties or functionalities can comprise those operable to undergo radiative or non-radiative induced polymerization mechanisms, including polycondensation or reaction between isocyanate and hydroxyl, for example. In some embodiments, the curable isocyanurate can comprise one or more reactive functionalities including, but not limited to, epoxy, amine, and thiol. Alternatively, one or more polymerizable functionalities can comprise one or more points of unsaturation suitable for free radical polymerization. In some such embodiments, the curable isocyanurate component comprises isocyanurate polyacrylate, polyallyl isocyanurate, or a mixture thereof. In some cases, the isocyanurate polyacrylate is of Formula IX:

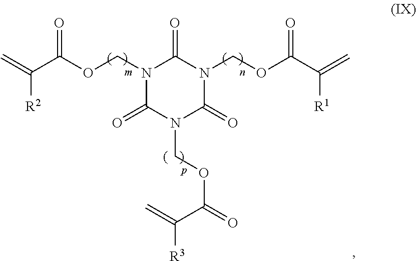

wherein R³-R⁵ are each independently selected from the group consisting of hydrogen and alkyl and m, n, and p are each integers independently ranging from 1 to 10. In some instances, the polyallyl isocyanurate is of Formula X:

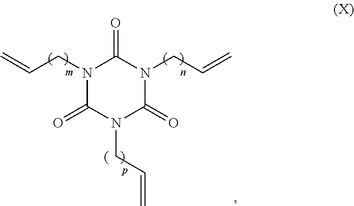

wherein m, n, and p are integers independently ranging from 1 to 10.

In some embodiments, the curable isocyanurate (when present) is present in an amount of 30-80 wt. %, 30-80 wt. %, 30-70 wt. %, 30-60 wt. %, 30-50 wt. %, 30-40 wt. %, 40-80 wt. %, 40-70 wt. %, 40-60 wt. %, 40-50 wt. %, 50-80 wt. %, 50-70 wt. %, 50-60 wt. %, 60-80 wt. %, 60-70 wt. %, or 70-80 wt. %, based on total weight of the composition.

Overall, the polymerizable component of a composition described herein, in total, can be present in an amount of 10-90 wt. %, 10-80 wt. %, 20-90 wt. %, 20-85 wt. %, 30-90 wt. %, 30-85 wt. %, 30-80 wt. %, 30-70 wt. %, 30-60 wt. %, 30-50 wt. %, 30-40 wt. %, 40-90 wt. %, 40-85 wt. %, 40-80 wt. %, 40-70 wt. %, 40-60 wt. %, 40-50 wt. %, 50-90 wt. %, 50-85 wt. %, 50-80 wt. %, 50-70 wt. %, 50-60 wt. %, 60-90 wt. %, 60-85 wt. %, 60-80 wt. %, 60-70 wt. %, 70-90 wt. %, 70-85 wt. %, or 70-80 wt. %, based on total weight of the composition.

Further, a polymerizable component described herein may be coated on a particle to form a core-shell configuration. Particles coated with the polymerizable component can have any desired chemical identity. The chemical identity of the particles can be selected according to several considerations including, but not limited to, the identity of the polymerizable component and the desired mechanical properties of the resultant article formed from the composition via additive manufacturing. In some embodiments, the particles comprise thermoplastic or thermoset materials. Alternatively, the particles can comprise elastomer. In some embodiments, for example, coated particles are commercially available from Kaneka Texas Corporation under the Kane Ace® MX trade designation. In some cases, particle coatings are operable to crosslink with the polymerizable component. Moreover, in some instances, the particle coating may crosslink with any other component present with a polymerizable moiety (e.g., functionalized Al₂O₃). In some implementations, the particles are present in an amount up to 10 wt. %, 8 wt. %, 6 wt. %, 4 wt. %, or 2 wt. %, based on total weight of the composition.

A composition described herein may further comprise a photoinitiator component for initiating polymerization of one or more components of the composition upon exposure to light of the proper wavelength. Any photoinitiator not inconsistent with the objectives of the present disclosure can be used. In some embodiments, a photoinitiator comprises an alpha-cleavage type (unimolecular decomposition process) photoinitiator or a hydrogen abstraction photosensitizer-tertiary amine synergist, operable to absorb light preferably between about 250 nm and about 420 nm or between about 300 nm and about 385 nm, to yield free radical(s).

Examples of alpha cleavage photoinitiators are Irgacure 184 (CAS 947-19-3), Irgacure 369 (CAS 119313-12-1), and Irgacure 819 (CAS 162881-26-7). An example of a photosensitizer-amine combination is Darocur BP (CAS 119-61-9) with diethylaminoethylmethacrylate.

In addition, in some instances, suitable photoinitiators comprise benzoins, including benzoin, benzoin ethers, such as benzoin methyl ether, benzoin ethyl ether and benzoin isopropyl ether, benzoin phenyl ether and benzoin acetate, acetophenones, including acetophenone, 2,2-dimethoxyacetophenone and 1,1-dichloroacetophenone, benzil, benzil ketals, such as benzil dimethyl ketal and benzil diethyl ketal, anthraquinones, including 2-methylanthraquinone, 2-ethylanthraquinone, 2-tert-butylanthraquinone, 1-chloroanthraquinone and 2-amylanthraquinone, triphenylphosphine, benzoylphosphine oxides, for example 2,4,6-trimethylbenzoyldiphenylphosphine oxide (Lucirin TPO) and phenylbis(2,4,6-trimethylbenzoyl) phosphineoxide (BAPO), benzophenones, such as benzophenone and 4,4′-bis(N,N′-dimethylamino)benzophenone, thioxanthones and xanthones, acridine derivatives, phenazine derivatives, quinoxaline derivatives or 1-phenyl-1,2-propanedione, 2-O-benzoyl oxime, 1-aminophenyl ketones or 1-hydroxyphenyl ketones, such as 1-hydroxycyclohexyl phenyl ketone, phenyl 1-hydroxyisopropyl ketone and 4-isopropylphenyl 1-hydroxyisopropyl ketone.

Suitable photoinitiators can also comprise those operable for use with a HeCd laser radiation source, including acetophenones, 2,2-dialkoxybenzophenones and 1-hydroxyphenyl ketones, such as 1-hydroxycyclohexyl phenyl ketone or 2-hydroxyisopropyl phenyl ketone (=2-hydroxy-2,2-dimethylacetophenone). Additionally, in some cases, suitable photoinitiators comprise those operable for use with an Ar laser radiation source including benzil ketals, such as benzil dimethyl ketal. In some embodiments, a photoinitiator comprises an α-hydroxyphenyl ketone, benzil dimethyl ketal or 2,4,6-trimethylbenzoyldiphenylphosphine oxide or a mixture thereof.

Another class of suitable photoinitiators, in some instances, comprises ionic dye-counter ion compounds capable of absorbing actinic radiation and generating free radicals for polymerization initiation. In some embodiments, the composition comprising ionic dye-counter ion compounds can be polymerized upon exposure to visible light within the adjustable wavelength range of about 400 nm to about 700 nm. Ionic dye-counter ion compounds and their mode of operation are disclosed in EP-A-0 223 587 and U.S. Pat. Nos. 4,751,102; 4,772,530; and 4,772,541.

A photoinitiator can be present in a composition described herein in any amount not inconsistent with the objectives of the present disclosure. In some embodiments, a photoinitiator is present in an amount of up to about 5 wt. %, based on the total weight of the composition. In some cases, a photoinitiator is present in an amount ranging from 0.1-5 wt. %, 0.5-5 wt. %, 1-5 wt. %, 2-5 wt. %, 3-5 wt. %, 4-5 wt. %, 0.1-4 wt. %, 0.5-4 wt. %, 1-4 wt. %, 2-4 wt. %, 3-4 wt. %, 0.1-3 wt. %, 0.5-3 wt. %, 1-3 wt. %, 2-3 wt. %, 0.1-2 wt. %, 0.5-2 wt. %, 1-2 wt. %, 0.1-1 wt. %, 0.5-1 wt. %, or 0.1-0.5 wt. %, based on the total weight of the composition.

Moreover, in some embodiments, a composition described herein can further comprise one or more sensitizers. A sensitizer can be added to increase the effectiveness of one or more photoinitiators that may also be present. Any sensitizer not inconsistent with the objectives of the present disclosure may be used. In some cases, a sensitizer comprises isopropylthioxanthone (ITX) or 2-chlorothioxanthone (CTX).

A sensitizer can be present in the composition in any amount not inconsistent with the objectives of the present disclosure. In some embodiments, a sensitizer is present in an amount ranging from about 0.1 wt. % to about 2 wt. % or from about 0.5 wt. % to about 1 wt. %, based on the total weight of the composition described herein.

In some embodiments, one or more UV-absorbers and/or light stabilizers can be present in the composition described herein. In some embodiments, for example, one or more UV-absorbers and/or light stabilizers can be present in an amount of 0.1-2 wt. %, based on the total weight of the composition. In some embodiments, UV-absorbers and/or light stabilizers are commercially available from BASF of Florham Park, New Jersey under the TINUVIN® trade-designation.

Further, in some cases, compositions described herein may further comprise a non-curable absorber material. A “non-curable absorber material,” for reference purposes herein, is a material or chemical species that is not curable or substantially curable by the curing radiation described herein and that absorbs at least a portion of the curing radiation, without causing substantial curing of other components of the ink. Thus, a “non-curable” absorber material can also be referred to as a “non-curing” or “non-reactive” absorber material. Moreover, a non-curable or non-curing absorber material described herein that is not “substantially” curable or that does not cause “substantial” curing is understood to convert (or use) less than 5%, less than 1%, less than 0.5%, or less than 0.1% of absorbed curing radiation photons into (or in) a curing event. For example, a non-curable (or non-curing) absorber material described herein, in some embodiments, can convert less than 2%, less than 1%, less than 0.5%, or less than 0.1% of absorbed photons into a free-radical species that can initiate or participate in polymerization or another curing process.

It is further to be understood that a non-curable or non-curing absorber material described herein can be a polymerization “spectator” (i.e., non-polymerizing or non-polymerization-initiating) species that nevertheless “competes” with a photoinitiator of the composition for absorption of photons of incident curing radiation (e.g., having a wavelength λ). Thus, in some cases, a non-curable absorber material and a photoinitiator of a composition described herein have substantially overlapping photon absorption profiles. In some instances, for example, both the non-curable absorber material and the photoinitiator have an absorption peak within 30 nm, within 20 nm, within 15 nm, within 10 nm, or within 5 nm of the wavelength λ.

Any non-curable absorber material not inconsistent with the objectives of the present disclosure may be used in a composition described herein. For example, in some embodiments, a non-curable absorber material comprises a polycyclic aromatic compound such as pyrene. A non-curable absorber material may also be a “dye” that has an absorption profile consistent with the description above. Such a “dye” may, more particularly, be a hydrophobic or oil-soluble dye. For instance, in some cases, the non-curable absorber material is a yellow dye, such as an oil-soluble yellow dye. Other yellow dyes could also be used. In other instances, a non-curable absorber material comprises a blue or green dye, such as a KEYPLAST dye commercially available from Keystone, Inc. Additionally, in some embodiments, which may not be preferred, a non-curable absorber material may have a broader absorption profile rather than a narrower absorption profile. For example, in some such cases, the non-curable absorber material comprises a black dye. Carbon black or another carbon allotrope may also be used as a non-curable absorber material, in some embodiments.

As described above, the non-curable absorber material component can be present in a composition described herein in an amount up to 10 wt. %, based on the total weight of the composition. For example, in some instances, a composition comprises up to 7 wt. %, up to 5 wt. %, up to 3 wt. %, up to 2 wt. %, or up to 1 wt. % non-curable absorber material. In some embodiments, a composition comprises 0.01-10 wt. %, 0.01-5 wt. %, 0.01-3 wt. %, 0.01-2 wt. %, 0.01-1 wt. %, 0.05-10 wt. %, 0.05-5 wt. %, 0.05-3 wt. %, 0.05-1 wt. %, 0.1-10 wt. %, 0.1-7 wt. %, 0.1-5 wt. %, 0.1-3 wt. %, 0.1-1 wt. %, 0.5-10 wt. %, 0.5-7 wt. %, 0.5-5 wt. %, 0.5-2 wt. %, 0.5-1 wt. %, 1-10 wt. %, 1-7 wt. %, 1-5 wt. %, or 1-3 wt. % non-curable absorber material, based on the total weight of the composition. In some especially preferred embodiments, the amount of non-curable absorber material is no more than about 1 wt. %. For example, in some preferred embodiments, a composition described herein comprises 0.0001-1 wt. %, 0.0001-0.5 wt. %, 0.0001-0.1 wt. %, 0.001-1 wt. %, 0.001-0.5 wt. %, 0.001-0.1 wt. %, 0.001-0.05 wt. %, 0.01-1 wt. %, 0.01-0.5 wt. %, 0.01-0.1 wt. %, or 0.01-0.05 wt. % non-curable absorber material, based on the total weight of the composition. The use of a relatively small amount of non-curable absorber material, such as one of the immediately preceding amounts, can be especially advantageous for maintaining or achieving desired mechanical properties of an article formed from a given composition in a given instance, since the “inert” non-curable absorber material can play the role of a non-reactive “filler” as well as being an optically relevant material during curing.

In some embodiments, a composition described herein further comprises a colorant or an emitter compound or compounds. The emitter compound can include a structure such that on exposure to a certain wavelength(s) of radiation, the emitter compound will produce a visible signal. In some implementations, the emitter compound(s) can include one or more colorants that produce a visible wavelength (e.g., red, green, blue, etc.) on exposure to natural light. When incorporated in the composition, the colorant(s) can be present in an amount of 0.1-5 wt. %, 0.1-3 wt. %, 0.1-2 wt. %, 0.1-1 wt. %, 0.1-0.5 wt. %, 0.5-5 wt. %, 0.5-4 wt. %, or 0.5-3 wt. %, based on total weight of the composition.

Additionally, in some cases, compositions described herein may further comprise a dispersant. For reference purposes herein, a dispersant can help to prevent aggregation of components of compositions. Non-limiting examples include those from BYK, including the BYK product line, such as BYK-151, BYK-153, and BYK-154, and the ANTI-TERRA product line, such as ANTI-TERRA-U, ANTI-TERRA-U 80, and ANTI-TERRA-U 100. When incorporated in the composition, the dispersant can be present in an amount of 0.1-10 wt. %, 0.5-10 wt. %, 0.1-5 wt. %, 0.1-3 wt. %, 0.1-2 wt. %, 0.1-1 wt. %, 0.1-0.5 wt. %, 0.5-5 wt. %, 0.5-4 wt. %, or 0.5-3 wt. %, based on total weight of the composition.

Moreover, in some implementations, compositions described herein may further comprise an anti-settling agent. For reference purposes herein, anti-settling agents can help to prevent sedimentation of components. Non-limiting examples include those from BYK, including the RHEOBYK product line, such as RHEONYK-410 and RHEOBYK-431. In some cases, the anti-settling agent may be present in the composition in an amount of 0.1-10 wt. %, 0.5-10 wt. %, 0.1-5 wt. %, 0.1-3 wt. %, 0.1-2 wt. %, 0.1-1 wt. %, 0.1-0.5 wt. %, 0.5-5 wt. %, 0.5-4 wt. %, or 0.5-3 wt. %, based on total weight of the composition.

Turning to additional additives, in some instances, a composition described herein may further comprise one or more additional additives that impart flame resistant or flame retardant properties, i.e., additional fire resistant additives. For example, in some implementations, a composition described herein may further comprise an organophosphorus component comprising one or more organophosphorus compounds. In some embodiments, the one or more organophosphorous compounds comprises one or more organophosphate compounds. Any organophosphate consistent with imparting flame resistant or flame retardant properties to the compositions and articles printed from the compositions can be employed. In some such embodiments, the one or more organophosphate compounds are of Formula XI:

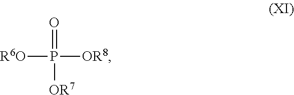

wherein R⁶-R⁸ are each independently selected from the group consisting of hydrogen, alkyl, alkenyl, alkynyl, cycloalkyl, heteroalkyl, heteroalkenyl, heterocyclyl, aryl, heteroaryl, and (meth)acryloyl. In some embodiments, for example, the one or more organophosphate compounds comprise aryl phosphate or heteroaryl phosphate. Aryl phosphates, in some embodiments, can include triphenyl phosphate. In other such embodiments, the one or more organophosphate compounds comprise a bis(organophosphate). Bis(organophosphates) can include resorcinol bis(diphenyl phosphate), bisphenol A bis(diphenyl phosphate) or mixtures thereof, in some embodiments.

Organophospate compounds of the composition, in some embodiments, are not halogenated. The organophosphate compounds, for example, are not halogenated with fluorine, chlorine, or bromine. Alternatively, the organophosphosphate compounds are halogenated with fluorine, chlorine, bromine, or combinations thereof. In some embodiments, for example, one or more of R⁶-R⁸ in Formula XI are halogenated, such as brominated.

Additionally, in some instances, an organophosphate component of compositions described herein may be functionalized with a polymerizable moiety. Any polymerizable moiety not inconsistent with the technical objects of the present disclosure may be used. For example, in some cases, a polymerizable moiety may comprise a (meth)acrylate moiety. Any (meth)acrylate moiety not inconsistent with the technical objects of the present disclosure may be used. In some implementations, the (meth)acrylate moiety may comprises a urethane (meth)acrylate moiety.

Moreover, turning to other organophosphorous compounds, in some instances, the one or more organophosphorous compounds comprises a phosphinate component. For example, in some such embodiments, the phosphinate component comprises a species of Formula XII:

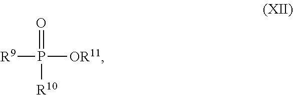

wherein R⁹, R¹⁰, and R¹¹ are each independently selected from the group consisting of hydrogen, alkyl, alkenyl, alkynyl, cycloalkyl, heteroalkyl, heteroalkenyl, heterocyclyl, aryl, and heteroaryl. In other such embodiments, the phosphinate component comprises a species of Formula XIII:

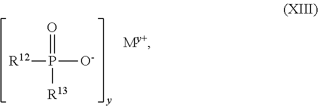

wherein R¹² and R¹³ are each independently selected from the group consisting of hydrogen, alkyl, alkenyl, alkynyl, cycloalkyl, heteroalkyl, heteroalkenyl, heterocyclyl, aryl, and heteroaryl; M is a metal; and y is an integer ranging from 1 to 3.

In some cases, the one or more organophosphorous compounds comprises a phosphonate. In some such instances, for example, the phosphonate component comprises a species of Formula XIV:

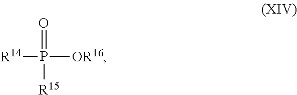

wherein R¹⁴, R¹⁵, and R¹⁶ are each independently selected from the group consisting of hydrogen, alkyl, alkenyl, alkynyl, cycloalkyl, heteroalkyl, heteroalkenyl, heterocyclyl, aryl, and heteroaryl. In other such instances, the phosphonate component comprises a species of Formula XV:

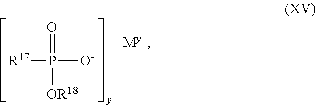

wherein R¹⁷ and R¹⁸ are each independently selected from the group consisting of hydrogen, alkyl, alkenyl, alkynyl, cycloalkyl, heteroalkyl, heteroalkenyl, heterocyclyl, aryl, and heteroaryl; M is a metal; and y is an integer ranging from 1 to 3. In other such cases, the phosphonate component comprises a species of Formula XVI:

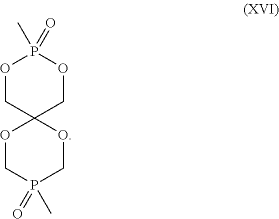

Further, in some embodiments, the one or more organophosphorus compounds comprises a species of Formula XVII:

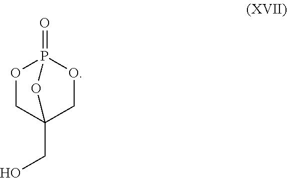

Additionally, an organophosphorus component described herein can be present in any amount not inconsistent with the technical objectives of the present disclosure. In some cases, for example, the organophosphorus component is present in an amount of up to 40 wt. %, up to 30 wt. %, up to 20 wt. %, 10 wt., % or up to 5 wt. %, based on the total weight the composition. In some instances, the organophosphorus component is present in an amount of 1-10 wt. %, 1-8 wt. %, 1-5 wt. %, 1-3 wt. %, 3-10 wt. %, 3-8 wt. %, 5-10 wt. %, or 5-8 wt. %, based on the total weight of the composition. In some other cases, the organophosphorus component is present in an amount of 10-40 wt. %, 20-40 wt. %, 30-40 wt. %, 20-30 wt. %, or 20-40 wt. % based on the total weight of the composition.

Moreover, in some embodiments, a composition described herein may further comprise a brominated acrylate ester component. The brominated acrylate ester component can comprise one or more acrylate or methacrylate esters having bromine atoms bonded to aliphatic carbons. In some embodiments, the brominated acrylate ester component comprises one or more compounds of Formula XVIII:

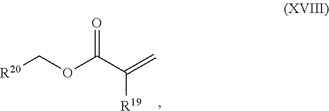

wherein R¹⁹ is selected from the group consisting of hydrogen and methyl, and wherein R²⁰ is selected from the groups consisting of brominated alkyl and brominated alkenyl. Brominated alkyl and brominated alkenyl groups are alkyl and alkenyl groups comprising one or more bromine substituents. In some embodiments, for example, the brominated acrylate ester component comprises trinol acrylate (Formula XIX):

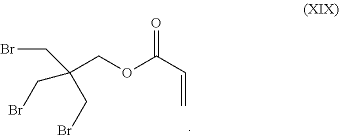

The brominated acrylate ester component can be present in the composition in any amount consistent with the technical objectives described herein of imparting flame resistance and/or flame retardant properties to articles printed from the composition in a 3D printing apparatus. The amount of brominated acrylate ester can be selected according to several considerations including, but not limited to, the desired flame resistant and mechanical properties of articles printed from the composition, and other species present in the composition, such as other flame retardant species. In some embodiments, brominated acrylate ester is present in an amount of 5-50 wt. %, 10-40 wt. %, or 15-35 wt. %, based on total weight of the composition described herein.

In some embodiment, a composition described herein may further comprise an additive of Formula XX:

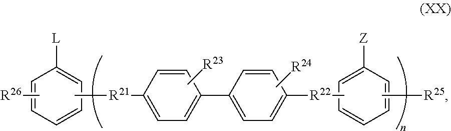

wherein L and Z are ring substituent comprising at least one polymerizable point of unsaturation, and wherein R²¹ and R²² are each independently selected from the group consisting of alkylene and alkenylene, and R²³-R²⁶ each represent one to four optional ring substituents, and each one of the one to four ring substituents is independently selected from the group consisting of alkyl, heteroalkyl, haloalkyl, halo, hydroxyl, alkoxy, amine, amide, and ether, and wherein x in Formula XX is an integer from 1 to 7 or from 1 to 5. It is understood that hydrogen occupies positions on the aryl rings of Formula XX in the absence of optional substituents R²³-R²⁶.

In certain implementations, one or both of the alkylene or alkenylene moieties R²¹ and/or R²² can have a carbon chain length of 1-8 carbon atoms, such as 1-5 carbon atoms, 1-3 carbon atoms, or 4-5 carbon atoms. In some embodiments, R²¹ and/or R²² comprises a C1-C10, C1-C8, or C1-C5 alkylene or alkenylene, where a “Cn” species (e.g., a “Cn” alkylene or alkenylene moiety) includes exactly “n” carbon atoms in the species (e.g., a “C5” species contains exactly 5 carbon atoms).

As used herein, an alkylene moiety is a linear or branched saturated hydrocarbon moiety, such as an “ethylene” (—CH₂CH₂—) moiety. An alkenylene moiety is a linear or branched hydrocarbon moiety that includes one carbon-carbon double bond, such as a “propenylene” (—CH₂CH═CH—) moiety.

In some embodiments, L and Z comprise one or more moieties or functional groups independently selected from the group consisting of vinyl, vinyl ether, allyl, acrylate, and methacrylate. Moreover, in some embodiments, L and/or Z can comprise a cyclopolymerizable moiety or functional group. For example, L and/or Z may comprise a cyclopolymerizable moiety or functionality of the formula:

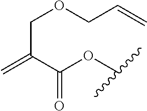 [SMILES: *OC(=O)C(=C)COCC=C]

where [symbol] is an attachment point of the cyclopolymerizable moiety or functionality to the compound of Formula XX.

One or more additives of Formula XX can be present in a composition described herein in any desired amount. Amount of an additive of Formula XX in the composition described herein can be selected according to several considerations including, but not limited to, desired mechanical properties and/or flame resistant properties of articles printed from the composition, and chemical identities and/or amounts of other species in the composition. In some embodiments, one or more additives of Formula XX are present in a composition described herein in a total amount of 5-40 wt. %, 5-30 wt. %, 5-20 wt. %, 5-10 wt. %, 10-40 wt. %, 10-30 wt. %, 10-20 wt. %, 20-40 wt. %, 20-30 wt. %, or 30-40 wt. %, based on total weight of the composition.

Moreover, compositions described herein can be produced in any manner not inconsistent with the objectives of the present disclosure. In some embodiments, for instance, a method for the preparation of a compositions described herein comprises the steps of mixing the components of the compositions, optionally melting the mixture, and filtering the (optionally molten) mixture. In some cases, the components are mixed and optionally melted at a temperature between about 25° C. and about 35° C., or at a temperature in the range of 25-55° C., 35-65° C., or 45-75° C. In some instances in which it is desirable or necessary to melt one or more solid components of the compositions, mixing and/or melting can be carried about a temperature in a range from about 75° C. to about 85° C. In some embodiments, a compositions described herein is produced by placing all components of the compositions in a reaction vessel, optionally heating the resulting mixture, and stirring the resulting mixture at a temperature between about 25° C. and about 75° C. or a temperature ranging from about 75° C. to about 85° C. The stirring (and optionally the heating) are continued until the mixture attains a substantially homogenized liquid (or molten) state. In general, the liquid (or molten) mixture can be filtered while in a flowable state to remove any large undesirable particles that may interfere with jetting or extrusion or other printing process. The filtered mixture can then be cooled to ambient temperatures (if cooling is needed) and stored until ready for use in a 3D printing system.

### II. Methods of Forming a 3D Article by Additive Manufacturing

In another aspect, methods of forming or “printing” a 3D article or object by additive manufacturing are described herein. Methods of forming a 3D article or object described herein can include forming the 3D article from a plurality of layers of a composition described herein in a layer-by-layer manner. In such cases, the composition can be used as a build material. It is also possible, in some embodiments, to use a composition described herein as a support material. Methods of forming a 3D article by additive manufacturing can also include forming the object in a manner other than a layer-by-layer manner. Any composition described hereinabove in Section I may be used in a method described herein. For example, in some embodiments, a method described herein comprises providing a composition, wherein the composition comprises an aluminum-containing species. In some cases, the aluminum-containing species comprises Al(OH)₃. Additionally, in some instances, the aluminum-containing species comprises a species of Formula I or Formula II:

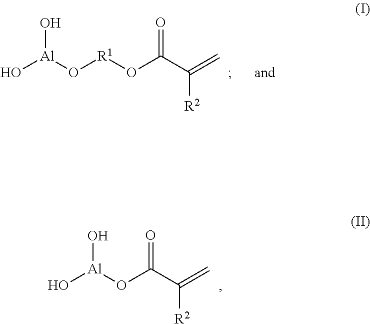

wherein R¹ is a C1-C10 alkyl or alkylene (e.g., CH₂) and R² is H or CH₃. Moreover, in some implementations, the aluminum-containing species comprises Al₂O₃ or alumina. In some instances, Al₂O₃ or alumina may be functionalized with one or more polymerizable groups. In some cases, the polymerizable group may comprise an acrylamide group. In some embodiments, the polymerizable group may comprise a (meth)acrylate. In some instances, the polymerizable group may comprise a vinyl group.

Turning to particular species of functionalized Al₂O₃, in some cases, the aluminum-containing species comprises a species of Formula III:

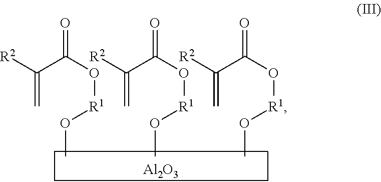

wherein R¹ is a C1-C10 alkyl (which may also be referred to as a C1-C10 “alkylene” moiety, as understood by one of ordinary skill in the art, and as described previously herein), R² is H or CH₃, and the box containing Al₂O₃ represents the surface of alumina or Al₂O₃. Moreover, in some cases, the aluminum-containing species comprises a species of Formula IV:

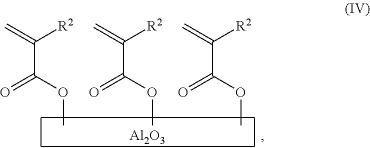

wherein R² is H or CH₃ and the box containing Al₂O₃ represents the surface of Al₂O₃. In some cases, the aluminum-containing species comprises a species of Formula V:

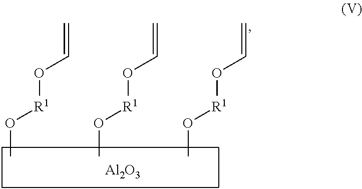

wherein R¹ is C1-C10 alkyl (or “alkylene”) and the box containing Al₂O₃ represents the surface of alumina or Al₂O₃. Further, in some implementations, the aluminum-containing species comprises a species of Formula VI:

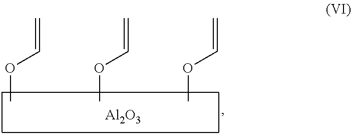

wherein the box containing Al₂O₃ represents the surface of alumina or Al₂O₃.

In some embodiments, layers of build material can be deposited according to an image of the 3D article in a computer readable format during formation of the three-dimensional article. The build material can be deposited according to preselected computer aided design (CAD) parameters. Moreover, in some cases, one or more layers of the build material described herein has a thickness of about 10 μm to about 100 μm, about 10 μm to about 80 μm, about 10 μm to about 50 μm, about 20 μm to about 100 μm, about 20 μm to about 80 μm, or about 20 μm to about 40 μm. Other thicknesses are also possible.

Additionally, it is to be understood that methods of printing a 3D article described herein can include so-called “multi-jet” or “stereolithography” or “DLP” 3D printing methods. For example, in some instances, a multi-jet method of printing a 3D article comprises selectively depositing layers of a build material described herein onto a substrate, such as a build pad of a 3D printing system. In addition, in some embodiments, a method described herein further comprises supporting at least one of the layers of the build material with a support material. Any support material not inconsistent with the objectives of the present disclosure may be used.

It is also possible to form a 3D article from a build material described herein using stereolithography or DLP printing. For example, in some cases, a method of printing a 3D article comprises retaining the composition or build material (e.g., as a polymerizable liquid) in a container and selectively applying energy to the build material in the container to solidify at least a portion of a build material, thereby forming a solidified layer that defines a cross-section of the 3D article. Additionally, a method described herein can further comprise raising or lowering the solidified layer to provide a new or second layer of build material, followed by again selectively applying energy to the build material in the container to solidify at least a portion of the new or second build material that defines a second cross-section of the 3D article. Further, the first and second cross-sections of the 3D article can be bonded or adhered to one another in the z-direction (or build direction corresponding to the direction of raising or lowering recited above) by the application of the energy for solidifying the build material. Moreover, selectively applying energy to the build material in the container can comprise applying electromagnetic radiation, such as UV and/or visible radiation, having a sufficient energy to initiate polymerization of the build material as described herein. In addition, in some cases, raising or lowering a solidified layer of build material is carried out using an elevator platform disposed in the container of fluid build material. A method described herein can also comprise planarizing a new layer of the build material provided by raising or lowering an elevator platform. Such planarization can be carried out, in some cases, by a wiper or roller.

### III. Compositions for Selective Laser Sintering

In one aspect, compositions for use in additive manufacturing applications are described herein. The compositions, for example, can be employed in SLS printing applications. A composition described herein, in some embodiments, comprises a sinterable powder in an amount of 10-99 wt. %, based on the total weight of the composition, and an aluminum-containing species. The aluminum-containing species may comprise any aluminum-containing species described in Section I.

For example, in some cases, the aluminum-containing species comprises Al(OH)₃. Additionally, in some instances, the aluminum-containing species comprises a species of Formula I or Formula II:

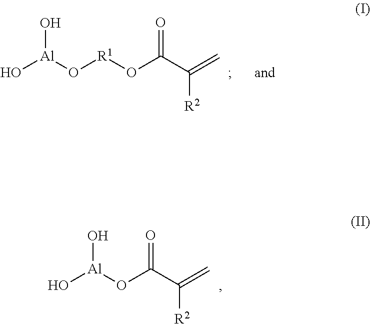

wherein R¹ is C1-C10 alkyl or alkylene (e.g., CH₂) and R² is H or CH₃.

Moreover, in some implementations, the aluminum-containing species comprises Al₂O₃ or alumina. In some instances, Al₂O₃ or alumina may be functionalized with one or more polymerizable groups. In some cases, the polymerizable group may comprise an acrylamide group. In some embodiments, the polymerizable group may comprise a (meth)acrylate. In some instances, the polymerizable group may comprise a vinyl group.

Turning to particular species of functionalized Al₂O₃, in some cases, the aluminum-containing species comprises a species of Formula III:

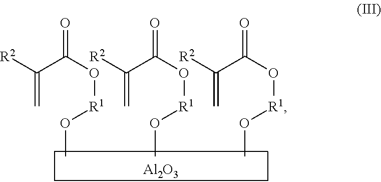

wherein R¹ is C1-C10 alkyl, R² is H or CH₃, and the box containing Al₂O₃ represents the surface of Al₂O₃. Moreover, in some cases, the aluminum-containing species comprises a species of Formula IV:

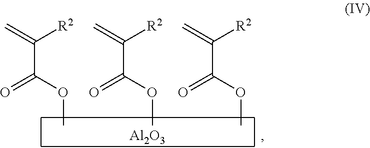

wherein R² is H or CH₃ and the box containing Al₂O₃ represents the surface of Al₂O₃. In some cases, the aluminum-containing species comprises a species of Formula V:

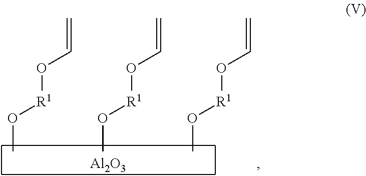

wherein R¹ is C1-C10 alkyl and the box containing Al₂O₃ represents the surface of Al₂O₃. Further, in some implementations, the aluminum-containing species comprises a species of Formula VI:

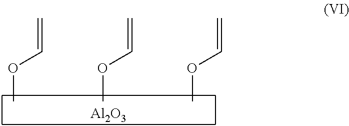

wherein the box containing Al₂O₃ represents the surface of Al₂O₃.

Turning to details of compositions comprising a sinterable powder described herein, in some implementations, the composition may comprise an aluminum-containing species in an amount of up to 20 wt. %, based on the total weight of the composition. Moreover, in some embodiments, the composition may comprise an aluminum-containing species in an amount of up to 18, 16, 14, 12, 10, 8, 6, 4, or 2 wt. %, based on the total weight of the composition. In some embodiments, the aluminum-containing species can be present in an amount of 2-20 wt. %, 2-18 wt. %, 2-16 wt. %, 2-14 wt. %, 2-12 wt. %, 2-10 wt. %, 2-8 wt. %, 2-6 wt. %, 2-4 wt. %, 4-20 wt. %, 4-18 wt. %, 4-16 wt. %, 4-14 wt. %, 4-12 wt. %, 4-10 wt. %, 4-8 wt. %, 4-6 wt. %, 6-20 wt. %, 6-18 wt. %, 6-16 wt. %, 6-14 wt. %, 6-12 wt. %, 6-10 wt. %, 6-8 wt. %, 8-20 wt. %, 8-18 wt. %, 8-16 wt. %, 8-14 wt. %, 8-12 wt. %, 8-10 wt. %, 10-20 wt. %, 6-18 wt. %, 6-16 wt. %, 6-14 wt. %, 6-12 wt. %, 12-20 wt. %, 12-18 wt. %, 12-16 wt. %, 12-14 wt. %, 14-20 wt. %, 14-18 wt. %, 14-16 wt. %, 16-20 wt. %, 16-18 wt. %, or 18-20 wt. %, based on the total weight of the composition.

Other components may also be included in a composition described herein. In some cases, a composition described herein comprising a sinterable powder may further comprise an organophosphorus component comprising one or more organophosphorus compounds. In such embodiments, it is to be understood that the organophosphorus component and the organophosphorus compounds can be the same as described above for the compositions described in Section I.

Moreover, in some embodiments, a composition described herein comprising a sinterable powder may further comprise a heptazine or melamine-derived component. Any heptazine or melamine-derived component not inconsistent with the technical objectives of the present disclosure may be used. In some instances, the heptazine or melamine-derived component is a derivative of or contains one or more structural units corresponding to heptazine or melamine. In some embodiments, for example, the heptazine or melamine-derived component comprises melem, melam, or melon. In some cases, the heptazine or melamine-derived component does not comprise melamine itself.

In some cases, the heptazine or melamine-derived component comprises a species of Formula XXI:

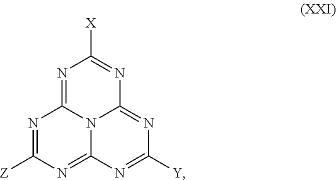

wherein X, Y, and Z are each independently selected from H and NR²⁷R²⁸; and
wherein R²⁷ and R²⁸ are each independently selected from H and a C1-C5 alkyl. For example, in some embodiments, X, Y, and Z are each H. In other cases, X, Y, and Z are each NH₂.

It is further to be understood that a “Cn” (or “Cn”) species described herein (such as a “Cn” alkyl) is a species (such as an alkyl moiety) that comprises or includes exactly “n” carbon atoms. Thus, C1-C5 alkyl groups can respectively comprise any alkyl group having exactly 1, 2, 3, 4, or 5 carbons.

In some embodiments described herein, R²⁷ and R²⁸ are each H, such that one or more of X, Y, and Z comprise NH₂. In some cases, R²⁷ and R²⁸ are each independently H, methyl, or ethyl.

In other embodiments, the heptazine or melamine-derived component comprises a species of Formula XXII:

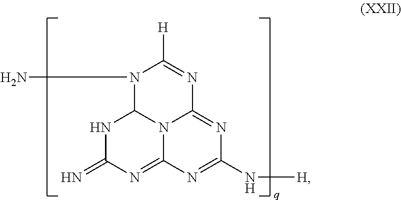

wherein Q is an integer from 2 to 1000.

In some embodiments, the heptazine or melamine-derived component comprises a species of Formula XXIII:

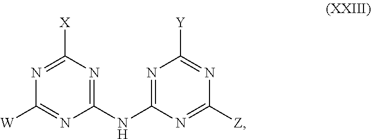

wherein W, X, Y, and Z are each independently selected from H and NR²⁷R²⁸, and
wherein R²⁷ and R²⁸ are each independently selected from H and a C1-C5 alkyl. For example, in some cases, W, X, Y, and Z are each NH₂.

Additionally, in some cases, the heptazine or melamine-derived component of an oxygen-deprivation additive described herein comprises a heptazine or melamine-derived oligomer. As known to the skilled artisan, an oligomer comprises a plurality of chemically linked monomers. Thus, a heptazine or melamine-derived oligomer comprises a plurality of chemically linked heptazine or melamine-derived units. In some cases, the heptazine or melamine-derived oligomer comprises highly condensed g-C₃N₄. In some embodiments, the heptazine or melamine-derived component comprises a species of Formula XXIV:

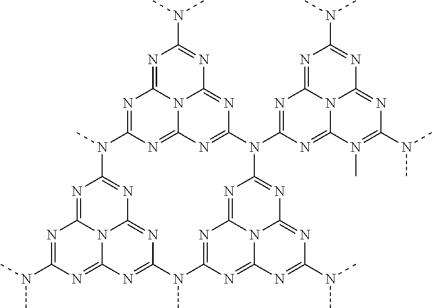

### (XXIV),

wherein the dashed bonds indicate crosslinks between repeating units. Heptazine or melamine-derived oligomers such as highly condensed g-C₃N₄ can be made according to methods such as that found in Ping, N.; Zhang, L.; Gang, L.; Cheng; H. I., Graphene-Like Carbon Nitride Nanosheets for Improved Photocatalytic Activities, Adv. Funct. Mater. 2012 (22), 4763-4770. Other heptazine or melamine-derived oligomers may also be used in a composition described herein.

A heptazine or melamine-derived component (or the total amount of the heptazine or melamine-derived component) described herein can be present in any amount not inconsistent with the technical objectives of the present disclosure. In some cases, for example, the heptazine or melamine-derived component is present in an amount of up to 24 wt. %, up to 20 wt. %, up to 15 wt. %, up to 10 wt. %, or up to 5 wt. %, based on the total weight the composition. In some instances, the heptazine or melamine-derived component is present in an amount of 1-24 wt. %, 1-20 wt. %, 1-15 wt. %, 1-10 wt. %, 1-5 wt. %, 5-24 wt. %, 5-20 wt. %, 5-15 wt. %, 10-24 wt. %, 10-20 wt. %, or 15-24 wt. %, based on the total weight of the composition.

Also, in some embodiments, compositions described herein comprising a sinterable powder may further comprise a polymeric organobromine component. Any polymeric organobromine component not inconsistent with the technical objectives of the present disclosure may be used. Additionally, a “polymeric” organobromine component can comprise a polymer in which the repeat unit is an organobromine unit, as opposed, for example, to a polymer that is bromine-terminated but does not include an organobromine moiety in the repeating unit of the polymer itself. A polymeric organobromine species described herein, in some cases, has a weight average molecular weight ranging from 500 to 10,000; 500 to 5,000; 1000 to 10,000; or 1000 to 5,000. Moreover, it is to be understood that the polymeric organobromine component of a composition described herein can differ from the organophosphorus component of the compositions. In some cases, the polymeric organobromine component comprises one or more of FR-122P, FR-803P (brominated polystyrene), FR-1025 (brominated polyacrylate), F-2001 (brominated epoxy), F-2200 HM (brominated epoxy), F-1600 (brominated epoxy), F-2100L (brominated epoxy), F-2100 (brominated epoxy), F-2100H (brominated epoxy), F-2400E (brominated epoxy), F-2400 (brominated epoxy), F-2400H (brominated epoxy), F-3014 (end-capped brominated epoxy), F-3020 (end-capped brominated epoxy), and F-3100 (end-capped brominated epoxy), all of which are commercially available from ICI Industrial Products.

A polymeric organobromine component (or the combination of all polymeric organobromine species) of an oxygen-deprivation additive described herein can be present in any amount not inconsistent with the technical objectives of the present disclosure. In some cases, for example, the polymeric organobromine component is present in an amount of up to 10 wt. %, up to 5 wt. %, up to 3 wt. %, or up to 1 wt. %, based on the total weight of the composition. In some instances, the polymeric organobromine component is present in an amount of 1-25 wt. %, 1-20 wt. %, 1-15 wt. %, 1-10 wt. %, 1-5 wt. %, 5-25 wt. %, 5-20 wt. %, 5-15 wt. %, 10-25 wt. %, 10-20 wt. %, or 15-25 wt. %, based on the total weight of the composition.

Additionally, in some embodiments, compositions described herein comprising a sinterable powder may further comprise an expandable graphite component (which may also be referred to in some cases as an exfoliated graphite component). Any expandable graphite component not inconsistent with the technical objectives of the present disclosure may be used. Moreover, as understood by one of ordinary skill in the art, an expandable graphite component can comprise or be formed from intercalated graphite sheets or flakes, wherein the intercalated graphite comprises an acidic intercalant or other intercalant, which intercalant may be molecular, atomic, or ionic. That is, in some implementations, an expandable graphite component described herein comprises graphite sheets (or a plurality of graphene layers) and one or more intercalants disposed between the graphite sheets (or the plurality of graphene layers). For example, in some cases, an expandable graphite component described herein comprises an intercalant comprising a molecular acid or an ionic form thereof.

In some instances, an expandable graphite component described herein is formed by treating natural flake graphite with one or more acids (such as HNO₃, H₂SO₄, H₃PO₄, HClO₄, and/or CH₃COOH) or oxidizing agents (such as KMnO₄, KClO₃, or H₂O₂). After treatment, the expandable graphite product can be washed with water to remove remaining acid and/or oxidizing reagent and then dried. Such treatment (or other treatments for providing expandable graphite) can produce graphite intercalation compounds (GICs). As understood by one of ordinary skill in the art, and not intending to be bound by theory, when a GIC is exposed to heat, the intercalated layers of graphite can further separate, causing the material to expand. Moreover, an expandable graphite component described herein, when heated, can form a protective char.

Further, in some embodiments, the surface chemistry of an expandable graphite component described herein, defined as the pH or pKa value at the flake surface of the expandable graphite component, can be modified to be acidic, basic, or neutral. In some instances, an expandable graphite component described herein has a pH or pKa value of 5-11, 5-9, 5-7, 7-9, 9-11, or 7-11.

Moreover, the expandable graphite component can have any expansion volume not inconsistent with the technical objectives of the present disclosure. For reference purposes herein, expansion volume is defined as the increase in volume a material will swell or expand when heated from room temperature to a given test temperature. That is, the expansion volume is the volume increase at the test temperature as compared to an initial temperature of room temperature (22° C.). For the expandable graphite component described herein, expansion volume can be assessed at 300° C., 500° C., 700° C., or 1000° C. For these test temperatures, the expandable graphite component described herein can exhibit an expansion volume of 80-400 cc/g, 100-400 cc/g, 150-400 cc/g, 200-400 cc/g, 100-300 cc/g, 200-300 cc/g, 300-400 cc/g, or 80-200 cc/g, where cc/g refers to cubic centimeter (or milliliter, mL) of expansion per gram of material. Other expansion volumes are also possible. Additionally, the expansion volume, in some cases, can be measured using thermomechanical analysis (TMA) or thermodilatometric analysis (TDA, which may also be referred to as zero force TMA).

Additionally, the expandable graphite component of a composition described herein can have a desirable onset temperature. For reference purposes herein, onset temperature is defined as the temperature at which the expanded graphite component begins to expand. In some embodiments, the expandable graphite component described herein has an onset temperature of 150-280° C., 150-190° C., 190-220° C., 220-250° C., 250-280° C., 150-220° C., 220-280° C., or 200-280° C. Other onset temperatures are also possible. Moreover, the onset temperature of an expandable graphite component described herein can be measured using TMA (e.g., zero force TMA in accordance with ASTM E831), where the onset temperature is assigned as the temperature at which volume expansion begins according to TMA.

In some embodiments, an expandable graphite component described herein can be used within the additive manufacturing composition as a free powder of the expandable graphite. In other embodiments, the expandable graphite component comprises expandable graphite encapsulated in a shell or encapsulating material. In some instances, the shell or encapsulating material can coat, surround, or contain the expandable graphite, such that the expandable graphite is completely (or substantially completely) disposed within the shell or capsule. For example, in some cases, the expandable graphite is at least 90%, at least 95%, at least 98%, or at least 99% contained or encapsulated within the shell or encapsulating material. The expandable graphite component of a composition described herein, in some embodiments, can thus be a core-shell component, wherein the core comprises or is formed from the expandable graphite itself, and the shell is formed from the encapsulating material.

Any shell or encapsulating material not inconsistent with the technical objectives of the present disclosure may be used. In some embodiments, for example, the shell or encapsulating material comprises or consists of another component of an additive manufacturing composition described herein. For example, in some cases, the shell or encapsulating material comprises or is formed from a material of a sinterable powder described herein, such as a semicrystalline polymer described hereinbelow or a filler material described hereinbelow. In other instances, the shell or encapsulating material comprises or is formed from a thermoplastic polymer described hereinbelow.

Moreover, in some cases, the shell or encapsulating material has a melting point that differs from the melting point or onset temperature of the expandable graphite that is encapsulated within the shell or encapsulating material. For instance, in some preferred embodiments, the encapsulating material has a melting point that is at least 30° C. lower or at least 20° C. lower than the onset temperature of the expandable graphite it encapsulates. In some cases, the encapsulating material has a melting point that is 20-60° C., 20-50° C., 20-40° C., 30-60° C., 30-50° C., or 30-40° C. lower than the onset temperature of the expandable graphite it encapsulates.

Further, when the expandable graphite component comprises a core-shell structure such as described above, the ratio of expandable graphite to shell material is not necessarily limited. In some embodiments, a core-shell expandable graphite component comprises at least 5 wt. %, at least 10 wt. %, at least 20 wt. %, or at least 30 wt. % shell material, based on the total weight of the expandable graphite component. In some cases, a core-shell expandable graphite component comprises 5-90 wt. %, 5-80 wt. %, 5-70 wt. %, 5-60 wt. %, 5-50 wt. %, 5-40 wt. %, 5-30 wt. %, 5-25 wt. %, 5-20 wt. %, 5-10 wt. %, 10-90 wt. %, 10-80 wt. %, 10-70 wt. %, 10-60 wt. %, 10-50 wt. %, 10-40 wt. %, 10-30 wt. %, 10-25 wt. %, 10-20 wt. %, 20-90 wt. %, 20-80 wt. %, 20-70 wt. %, 20-60 wt. %, 20-50 wt. %, 20-40 wt. %, 20-30 wt. %, 30-90 wt. %, 30-80 wt. %, 30-70 wt. %, 30-60 wt. %, 30-50 wt. %, or 30-40 wt. % shell material, based on the total weight of the expandable graphite component, with the balance being the expandable graphite.

Additionally, the expandable graphite component of a composition described herein can have one or more properties advantageous for use in additive manufacturing (in addition to having intumescent properties as described above). For example, in some embodiments, the expandable graphite component is a particulate material (whether core-shell or otherwise) and has an average particle size in three dimensions (e.g., a D50 value) of 50-350 μm, 75-350 μm, 100-350 μm, 125-350 μm, 75-325 μm, 75-275 μm, 75-225 μm, 80-200 μm, 150-200 μm, or 150-350 μm. In some preferred embodiments, for instance, a core-shell expandable graphite component described herein has an average particle size (e.g., D50) of 50-200 μm, 50-175 μm, 50-150 μm, 50-125 μm, 50-100 μm, 50-80 μm, 80-200 μm, 80-175 μm, 80-150 μm, 80-125 μm, 80-100 μm, 100-125 μm, 100-150 μm, 100-175 μm, 100-200 μm, 125-200 μm, 125-150 μm, 125-175 μm, 125-200 μm, 150-175 μm, 150-200 μm, or 175-200 μm. Particle sizes described herein can be measured using any suitable method known to one of ordinary skill in the art. For example, in some preferred embodiments, particle size is determined using sieve analysis, including in accordance with ASTM D1921. Further, a particulate expandable graphite component described herein, in some implementations, has a monomodal particle size distribution (PSD), as opposed to a bimodal or other higher order PSD.

Moreover, in some cases, the particle size of a particulate expandable graphite component is selected with reference to (or in combination with) the size of another particulate material of a composition described herein and/or with respect to a printing parameter. For example, in some embodiments, a sinterable powder of a composition described herein has an average particle size in three dimensions (e.g., a D50 determined in accordance with ASTM D1921), and the expandable graphite component is a particulate material having an average particle size in three dimensions (e.g., a D50 value determined in accordance with ASTM D1921). Additionally, in some such instances, the average particle size of the expandable graphite component is larger than the average particle size of the sinterable powder. For example, in some such cases, the average particle size of the sinterable powder is 60-300 μm, and the average particle size of the expandable graphite component is 80-350 μm. In other such embodiments (in which the expandable graphite component has a larger average size than the sinterable powder), the average particle size of the sinterable powder is 60-150 μm, and the average particle size of the expandable graphite component is 80-200 μm. Not intending to be bound by theory, it is believed that such a combination of particle sizes can unexpectedly permit formation of fire or flame resistant articles through an additive manufacturing process, where the formed articles have high resolution and fire/flame resistant properties, without suffering from printing defects typically caused by the presence of relatively large additive particles such as the expandable graphite component particles described above.

Additionally, in some cases, a particulate expandable graphite component (such as an expandable graphite component having a core-shell structure described above), has high roundness, sphericity, and/or flowability. For example, in some embodiments, a particulate expandable graphite component (such as a core-shell expandable graphite component) has an average aspect ratio (the average ratio of largest length or dimension of a particle compared to the smallest length or dimension of the particle) of 0.8 to 1.2. For example, in some cases, a particulate expandable graphite component (e.g., a core-shell expandable graphite component) may have an average aspect ratio of 0.9-1.1. The aspect ratio of a particle can be measured or determined in any manner known to one of ordinary skill in the art. In some preferred embodiments, for instance, the average aspect ratio of a population of expandable graphite component particles is determined using dynamic image analysis in accordance with ISO 13322-2:2021.

Similarly, in some implementations, a particulate expandable graphite component (e.g., an expandable graphite component having a core-shell structure) has a Hausner ratio of 1.0 to 1.2. In some instances, a particulate expandable graphite component has a Hausner ratio of less than 1.1, such as between 1.0 and 1.1. As understood by one of ordinary skill in the art, the Hausner ratio is the ratio of tap (or tapped or tamped) density (measured according to ASTM B527) to apparent density (measured according to ASTM D1895B).

Further, a particulate expandable graphite component described herein (such as an expandable graphite component having a core-shell structure described above) can have a combination of two or more of the features described above, such as an average particle size described above, an average aspect ratio described above, and a Hausner ratio described above.

An expandable graphite component described herein can be present in any amount not inconsistent with the technical objectives of the present disclosure. In some cases, for example, the expandable graphite component is present in an amount of up to 20 wt. %, up to 15 wt. %, up to 10 wt. %, or up to 5 wt. %, based on the total weight the composition. In some instances, the expandable graphite component is present in an amount of 1-20 wt. %, 1-15 wt. %, 1-10 wt. %, 1-5 wt. %, 5-20 wt. %, 5-15 wt. %, 10-15 wt. %, or 10-20 wt. %, based on the total weight of the composition. In some cases, the expandable graphite component is present in an amount of no more than 20 wt. %, based on the total weight of the composition.

Additionally, in some cases, a composition comprising a sinterable powder described herein excludes or contains very small amounts of certain components. For instance, in some cases, a composition described herein is free or substantially free of phosphate. A composition described herein that is “substantially free of” phosphate can, in some embodiments, comprise or include less than 5 wt. %, less than 3 wt. %, less than 1 wt. %, or less than 0.5 wt. % phosphate, based on the total weight of the composition. In some cases, a composition that is substantially free of phosphate comprises less than 0.1 wt. % or less than 0.01 wt. % phosphate, based on the total weight of the composition.

Turning to the sinterable powder component, as understood by a person of ordinary skill in the art, a “sinterable” powder can be selectively sintered or fused by application of energy, such as provided by a laser beam or other source of electromagnetic radiation. The application of energy (e.g., a selectively applied laser beam) can selectively heat powder particles, with the result that the powder partially melts and adjacent particles fuse with one another. “Sintering” can thus in some cases include the heating of the powder to a temperature which causes viscous flow only at contiguous boundaries of the individual powder particles, with at least some portion of substantially all particles remaining solid. As described above, such sintering can cause coalescence of particles into a sintered solid mass, the bulk density of which is increased compared to the bulk density of the powder particles before they were sintered. Such fusing can provide a solidified portion (e.g., a cross-section or layer) of an article or object being printed or formed by the process. An article or object formed by layer-by-layer or “slice-wise” joining of vertically contiguous layers which are sintered into stacked “layers” or “slices” can thus be described as autogenously densified. Such slices or layers can have a thickness of, for example, up to about 250 μm, such as in the range of 50 μm to 180 μm.

A sinterable powder of the present disclosure can thus have optical properties, thermal properties, and other properties suitable for use with a 3D printing system or method that forms objects by fusing or sintering individual powder particles together in a selective way. For instance, a sinterable powder can have optical (e.g., absorbance) and/or thermal properties (e.g., glass transition temperature, T_{g}; melting point, MP; or crystallization temperature T_{c}) selected for sintering with a particular source of electromagnetic radiation. In some embodiments, a sinterable powder described herein has a non-zero absorbance or an absorbance peak at the wavelength used in the 3D printing process (e.g., at the peak wavelength of the laser, such as a CO₂ laser, used in an SLS process). Moreover, in some cases, a sinterable powder described herein has a sintering window (defined as the metastable thermodynamic region between melting and crystallization, or the difference between the MP onset and T_{c} onset) of at least 10° C., such as a sintering window of 10-30° C., 10-25° C., or 10-20° C., when measured by differential scanning calorimetry (DSC) using a heating rate of 10° C./min. Additionally, in some instances, a sinterable powder described herein has an MP of 120-270° C., 150-250° C., 150-200° C., 150-180° C., 170-250° C., 170-220° C., 170-200° C., 190-250° C., 190-220° C., or 200-250° C.

Additionally, in some cases, a sinterable powder can have an average particle size and a flowability suitable for use in such an additive manufacturing method. For example, in some embodiments, a sinterable powder described herein has an average particle size (D50) of 60-300 μm, 60-250 μm, 60-200 μm, 60-150 μm, 60-100 μm, 80-300 μm, 80-250 μm, 80-200 μm, 80-150 μm, 80-100 μm, 100-300 μm, 100-250 μm, 100-200 μm, 150-300 μm, 150-250 μm, 150-200 μm, 200-300 μm, or 200-250 μm. A sinterable powder described herein, in some implementations, has a monomodal particle size distribution (PSD), as opposed to a bimodal or other higher order PSD. Average particle size and particle size distribution can be measured in accordance with ASTM D1921.

Further, in some cases, a sinterable powder described herein has a normalized packing density of 20-45% or 25-40%. Moreover, in some embodiments, a sinterable powder described herein has an average roundness (defined as the ratio between the measured area of a particle and the area of an equivalent circle with the maximum length of the particle as diameter) of 0.4 to 0.6. Average roundness can be measured using dynamic image analysis. Moreover, in some embodiments, a sinterable powder described herein has a bulk density and/or a tap (or tapped or tamped) density above 0.35 g/mL or above 0.4 g/mL, such as a bulk and/or tap (or tapped or tamped) density between 0.35 and 1 g/mL or between 0.4 and 1 g/mL, when measured in accordance with ASTM D1895B (bulk density) or ASTM B527 (tap density).

Any sinterable powder not inconsistent with the objectives of the present disclosure may be used. In some cases, the sinterable powder comprises a semicrystalline polymer, including in some instances as a primary or majority component (by mass or weight) of the sinterable powder. Any semicrystalline polymer not inconsistent with the objectives of the present disclosure may be used. In some implementations, the sinterable powder of a composition described herein comprises (or primarily comprises as the majority component) a polyamide (PA), a polyester (PEs), a polyurethane (PU), a polyethyelene (PE), a polypropylene (PP), a poly(butylene terephthalate) (PBT), a poly(etheretherketone) (PEEK), a poly(etherketoneketone) (PEKK), or a combination of two or more of the foregoing. When the sinterable powder comprises a polyamide (PA), any PA not inconsistent with the objectives of the present disclosure may be used. For example, in some cases, the PA comprises polyamide-11 (PA 11), polyamide-12 (PA 12), or a combination of PA 11 and PA 12.

In some instances, the PA comprises a polyamide comprising or formed from one or more lactams, such as the combination of laurolactam and caprolactam. In some such embodiments, the proportion of caprolactam is 40-60 mol. % of the total lactams used. Moreover, in some embodiments, a polyamide comprising or formed from laurolactam and caprolactam as described above may form all or part of a sinterable powder of a composition described herein. For example, in some cases, such a polyamide is the primary or majority component of a sinterable powder composition. For instance, in some embodiments, the polyamide powder formed from laurolactam and caprolactam forms up to 100 wt. %, up to 99 wt. %, up to 95 wt. %, or up to 90 wt. % of the sinterable powder, based on the total weight of the sinterable powder. In some instances, the sinterable powder comprises 50-100 wt. %, 50-99 wt. %, 50-90 wt. %, 50-80 wt. %, 50-70 wt. %, 60-100 wt. %, 60-99 wt. %, 60-90 wt. %, 70-100 wt. %, 70-99 wt. %, 70-90 wt. %, 80-100 wt. %, 80-99 wt. %, 80-95 wt. %, 85-100 wt. %, 85-99 wt. %, 85-95 wt. %, 90-100 wt. %, or 90-99 wt. % polyamide powder described above, based on the total weight of the sinterable powder.

Turning again more generally to the sinterable powder of a composition described herein, a sinterable powder described herein, in some cases, comprises up to 100 wt. %, up to 99 wt. %, up to 95 wt. %, or up to 90 wt. % semicrystalline polymer, based on the total weight of the sinterable powder (not based on the total weight of the overall composition). In some instances, the sinterable powder comprises 50-100 wt. %, 50-99 wt. %, 50-90 wt. %, 50-80 wt. %, 50-70 wt. %, 60-100 wt. %, 60-99 wt. %, 60-90 wt. %, 70-100 wt. %, 70-99 wt. %, 70-90 wt. %, 80-100 wt. %, 80-99 wt. %, 80-95 wt. %, 85-100 wt. %, 85-99 wt. %, 85-95 wt. %, 90-100 wt. %, or 90-99 wt. % semicrystalline polymer, based on the total weight of the sinterable powder.

In addition to a primary or majority component such as described above, a sinterable powder described herein can also comprise one or more additional components. In some embodiments, for instance, the sinterable powder comprises a filler material. Any filler material not inconsistent with the objectives of the present disclosure may be used. For example, in some cases, the filler material comprises glass, ceramic, or carbon fiber. In some embodiments, the filler material is in the form of spheres, plates, or fibers, and the shape of any filler material is not particularly limited.

A filler material, if used, can be present in the sinterable powder in any amount not inconsistent with the technical objectives of the present disclosure. For example, in some cases, a sinterable powder described herein comprises up to 30 wt. %, up to 20 wt. %, up to 15 wt. %, or up to 10 wt. % filler material, based on the total weight of the sinterable powder (not based on the total weight of the overall composition). In some instances, the sinterable powder comprises 1-30 wt. %, 1-25 wt. %, 1-20 wt. %, 1-15 wt. %, 1-10 wt. %, 1-5 wt. %, 5-30 wt. %, 5-25 wt. %, 5-20 wt. %, 5-15 wt. %, or 5-10 wt. % filler material, based on the total weight of the sinterable powder.

A sinterable powder described herein may also comprise a flowing agent. Any flowing agent not inconsistent with the technical objectives of the present disclosure may be used. For example, in some cases, a flowing agent comprises a nanoparticulate coating or other coating on the sinterable powder or on a semicrystalline polymer of the sinterable powder, such as a silica nanoparticle coating. One example of a flowing agent suitable for use in some embodiments described herein is Aerosil 200.

A flowing agent, if used, can be present in the sinterable powder in any amount not inconsistent with the technical objectives of the present disclosure. For example, in some cases, a sinterable powder described herein comprises up to 10 wt. %, up to 5 wt. %, up to 1 wt. %, or up to 0.5 wt. % flowing agent, based on the total weight of the sinterable powder (not based on the total weight of the overall composition). In some instances, the sinterable powder comprises 0.01-10 wt. %, 0.01-5 wt. %, or 0.01-1 wt. % flowing agent, based on the total weight of the sinterable powder.

### IV. Methods of Forming a 3D Article by Sintering

Methods of additive manufacturing are also described herein. Such methods of forming or printing a 3D article, object, or part can include forming the 3D article from a plurality of layers of composition described in Section III, as a build material, including in a layer-by-layer manner. Any composition described hereinabove in Section III may be used. Further, the layers of a composition can be formed or provided according to an image of the 3D article in a computer readable format, such as according to preselected computer aided design (CAD) parameters.

In some embodiments, such methods can include SLS or other sintering methods. An SLS method, as understood by one of ordinary skill in the art, can comprise retaining a composition described herein in a container (such as a build bed or powder bed) and selectively applying energy to the composition in the container to solidify (or consolidate or sinter) at least a portion of a layer of the composition, thereby forming a solidified (or consolidated or sintered) layer that defines a cross-section of the 3D article. Additionally, a method described herein can further comprise raising or lowering the solidified layer of the composition to provide a new or second layer of unsolidified composition at the surface of the composition in the container, followed by again selectively applying energy to the composition in the container to solidify (or consolidate or sinter) at least a portion of the new or second layer of the composition to form a second solidified layer that defines a second cross-section of the 3D article. Further, the first and second cross-sections of the 3D article can be bonded or adhered to one another in the z-direction (or build direction corresponding to the direction of raising or lowering recited above) by the application of the energy for solidifying (or consolidating or sintering) the composition. Moreover, selectively applying energy to the composition in the container can comprise applying electromagnetic radiation having a sufficient energy to solidify (or consolidate or sinter) the composition. In some instances, the electromagnetic radiation has an average wavelength of 300-1500 nm. In some cases, the solidifying (or consolidating or sintering) radiation is provided by a computer controlled laser beam. In addition, in some cases, raising or lowering a solidified layer of composition is carried out using an elevator platform disposed in the container. A method described herein can also comprise planarizing a new layer of the composition provided by raising or lowering an elevator platform, or rolling out a new layer of the composition. Such planarization or rolling can be carried out, in some cases, by a wiper or roller.

It is further to be understood that the foregoing process can be repeated a desired number of times to provide the 3D article. For example, in some cases, this process can be repeated “n” number of times, wherein n can be up to about 100,000, up to about 50,000, up to about 10,000, up to about 5000, up to about 1000, or up to about 500. Thus, in some embodiments, a method of printing a 3D article described herein can comprise selectively applying energy to a composition in a container to solidify (or consolidate or sinter) at least a portion of an nth layer of the composition, thereby forming an nth solidified layer that defines an nth cross-section of the 3D article, raising or lowering the nth solidified layer of the composition to provide an (n+1)th layer of unsolidified composition at the surface of the composition in the container, selectively applying energy to the (n+1)th layer of the composition in the container to solidify at least a portion of the (n+1)th layer of the composition to form an (n+1)th solidified layer that defines an (n+1)th cross-section of the 3D article, raising or lowering the (n+1)th solidified layer of the composition to provide an (n+2)th layer of unsolidified composition at the surface of the composition in the container, and continuing to repeat the foregoing steps to form the 3D article. Further, it is to be understood that one or more steps of a method described herein, such as a step of selectively applying energy to a layer of composition, can be carried out according to an image of the 3D article in a computer-readable format.

Thus, in some embodiments, a method of printing a 3D article described herein comprises providing a composition described hereinabove and selectively solidifying layers of the composition to form the article. Moreover, in some cases, the composition is provided in a layer-by-layer process. In some cases, the method is an SLS or other particle sintering method of additive manufacturing.

### V. Compositions for Fused Deposition Modeling

In some aspects, compositions for additive manufacturing are described herein, wherein the composition comprises a thermoplastic polymer in an amount of 10-99 wt. %, based on the total weight of the composition, and an aluminum-containing species. The aluminum-containing species may comprise any aluminum-containing species described in Section I.

For example, in some cases, the aluminum-containing species comprises Al(OH)₃. Additionally, in some instances, the aluminum-containing species comprises a species of Formula I or Formula II:

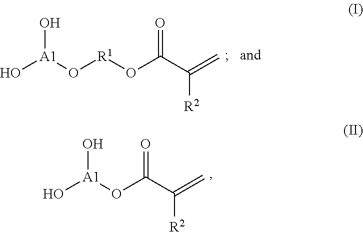

wherein R¹ is C1-C10 alkyl or alkylene (e.g., CH₂) and R² is H or CH₃.

Moreover, in some implementations, the aluminum-containing species comprises Al₂O₃ or alumina. In some instances, Al₂O₃ or alumina may be functionalized with one or more polymerizable groups. In some cases, the polymerizable group may comprise a (meth)acrylamide group. In some embodiments, the polymerizable group may comprise a (meth)acrylate. In some instances, the polymerizable group may comprise a vinyl group.

Turning to particular species of functionalized Al₂O₃, in some cases, the aluminum-containing species comprises a species of Formula III:

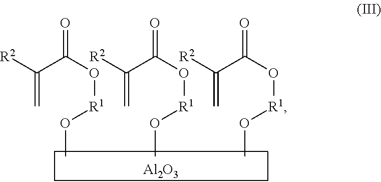

wherein R¹ is C1-C10 alkyl, R² is H or CH₃, and the box containing Al₂O₃ represents the surface of Al₂O₃. Moreover, in some cases, the aluminum-containing species comprises a species of Formula IV:

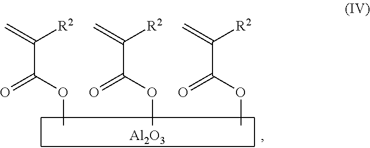

wherein R² is H or CH₃ and the box containing Al₂O₃ represents the surface of Al₂O₃. In some cases, the aluminum-containing species comprises a species of Formula V:

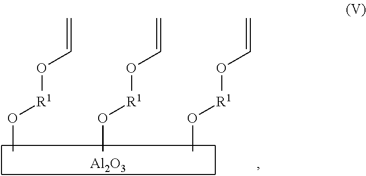

wherein R¹ is C1-C10 alkyl and the box containing Al₂O₃ represents the surface of Al₂O₃. Further, in some implementations, the aluminum-containing species comprises a species of Formula VI:

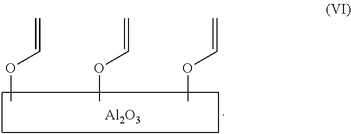

Moreover, turning to additional details about the composition, in some implementations, the composition may comprise an aluminum-containing species in an amount of up to 20 wt. %, based on the total weight of the composition. Moreover, in some embodiments, the composition may comprise an aluminum-containing species in an amount of up to 18, 16, 14, 12, 10, 8, 6, 4, or 2 wt. %, based on the total weight of the composition. In some embodiments, the aluminum-containing species can be present in an amount of 2-20 wt. %, 2-18 wt. %, 2-16 wt. %, 2-14 wt. %, 2-12 wt. %, 2-10 wt. %, 2-8 wt. %, 2-6 wt. %, 2-4 wt. %, 4-20 wt. %, 4-18 wt. %, 4-16 wt. %, 4-14 wt. %, 4-12 wt. %, 4-10 wt. %, 4-8 wt. %, 4-6 wt. %, 6-20 wt. %, 6-18 wt. %, 6-16 wt. %, 6-14 wt. %, 6-12 wt. %, 6-10 wt. %, 6-8 wt. %, 8-20 wt. %, 8-18 wt. %, 8-16 wt. %, 8-14 wt. %, 8-12 wt. %, 8-10 wt. %, 10-20 wt. %, 6-18 wt. %, 6-16 wt. %, 6-14 wt. %, 6-12 wt. %, 12-20 wt. %, 12-18 wt. %, 12-16 wt. %, 12-14 wt. %, 14-20 wt. %, 14-18 wt. %, 14-16 wt. %, 16-20 wt. %, 16-18 wt. %, or 18-20 wt. %, based on the total weight of the composition.

In such embodiments, it is to be understood that the composition comprising a thermoplastic polymer may comprise any other additive or component described above in Section III (such as an organophosphorus component) for compositions comprising a sinterable powder instead of a thermoplastic polymer.

Additionally, the thermoplastic polymer of the composition can comprise any thermoplastic polymer not inconsistent with the technical objectives of the present disclosure. For example, in some cases, the thermoplastic polymer comprises an acrylonitrile butadiene styrene (ABS), a polylactic acid (PLA), a polyethylene terephthalate (PET), a thermoplastic polyurethane (TPU), a nylon, a polycarbonate, or a combination, block copolymer, or melt of two or more of the foregoing.

### VI. Methods of Forming a 3D Article by Fused Deposition Modeling

A composition described in Section V can be used in material deposition methods of additive manufacturing, such as FDM. In a material deposition method, one or more layers of a composition described herein are selectively deposited onto a substrate as a build material and solidified. Solidifying, in some cases, comprises rapid cooling of the composition or the composition's undergoing of a phase transition (e.g., from liquid to solid).

Thus, in some instances, a composition (or build material) described herein is selectively deposited in a fluid state onto a substrate, such as a build pad of a 3D printing system. Selective deposition may include, for example, depositing the build material according to preselected CAD parameters. For example, in some embodiments, a CAD file drawing corresponding to a desired 3D article to be printed is generated and sliced into a sufficient number of horizontal slices. Then, the build material is selectively deposited, layer by layer, according to the horizontal slices of the CAD file drawing to print the desired 3D article. A “sufficient” number of horizontal slices is the number necessary for successful printing of the desired 3D article, e.g., to produce it accurately and precisely.

Further, in some embodiments, a preselected amount of build material described herein is heated to the appropriate temperature and extruded or expelled from a nozzle or print head or a plurality of nozzles or print heads of a suitable printer to form a layer on a print pad in a print chamber. In some cases, each layer of build material is deposited according to preselected CAD parameters. As stated above, in some embodiments, a composition (or build material) described herein exhibits a phase change upon deposition and/or solidifies upon deposition. Moreover, in some cases, the temperature of the printing environment can be controlled so that the deposited portions of build material solidify on contact with the receiving surface. Additionally, in some instances, after each layer is deposited, the deposited material is planarized prior to the deposition of the next layer. Optionally, several layers can be deposited before planarization. Planarization corrects the thickness of one or more layers by evening the dispensed material to remove excess material and create a uniformly smooth exposed or flat up-facing surface on the support platform of the printer. In some embodiments, planarization is accomplished with a wiper device, such as a roller, which may be counter-rotating in one or more printing directions but not counter-rotating in one or more other printing directions. In some cases, the wiper device comprises a roller and a wiper that removes excess material from the roller. Further, in some instances, the wiper device is heated. It should be noted that the consistency of the deposited build material described herein, in some embodiments, should desirably be sufficient to retain its shape and not be subject to excessive viscous drag from the planarizer. Layered deposition of the build material can be repeated until the 3D article has been formed.

### VII. Articles Formed by Methods and Compositions Described Herein

Compositions and methods described herein can be used to provide 3D articles with flame or fire resistant or retardant properties. Articles may be formed from any composition described in Section I for additive manufacturing and by any particular method described in Section II for additive manufacturing. Articles may also be formed from any composition described in Section III and formed by any method described in Section IV, particularly for methods of sintering. Articles may be formed from any composition described in Section V and formed by any method described in Section VI, particularly for methods of fused deposition modeling.

In some embodiments, a 3D article formed using compositions and/or methods described herein passes FAR 25.853 (60 second and 12 second), e.g., upon completion of printing (and optionally after an additional time period post-printing, such as a time period of 1-4 hours, without any post-curing). Testing sample thickness passing FAR 25.853 (60 second and 12 second) can be less than 2 mm or less than 1 mm, such as 0.8 mm or 0.4 mm, in some embodiments. In some instances, the articles provided by the compositions and methods described herein, for example, can exhibit a limiting oxygen index (LOI) of 25-30% or 28-30% according to ISO 4589. In some cases, the article has a v0 rating according to UL 94V. In other cases, the article has a v1 rating according to UL 94V.

Moreover, in some cases, compositions and methods described herein can provide articles with desirable mechanical properties. In some such instances, a 3D article formed using compositions and/or methods described herein has a Tensile Strength (TS) Ratio of at least 1.0. In other such instances, the article has a Tensile Strength (TS) Ratio of greater than 1.0. The TS Ratio is based on comparing the TS of a 3D article formed from a composition described herein to TS of an otherwise identical 3D article formed in an otherwise identical manner from a composition that is the same as described herein, except omitting the fire resistant additive of the present invention. The TS of a test sample (e.g., the 3D article formed from the composition) is measured following printing of the 3D article (e.g., within 12 hours) and at the same time point post-printing for comparison purposes. The same test method (e.g., ASTM D638) is also used for testing both samples/3D articles in a compared set of samples/3D articles. The Ratio is based on the numerator being the property value (e.g., TS) of the 3D article that includes the fire resistant additive; the denominator is thus the corresponding property value (e.g., TS) of the otherwise similar 3D article that does not include the fire-resistant additive.

### EXAMPLES

Some embodiments of compositions for 3D printing are illustrated in the following non-limiting Examples.

Table 1 provides formulations of compositions for additive manufacturing according to some embodiments described herein, specifically example compositions using a polymerizable component. In Table 1, “Comp.” means “Composition.” Table 1 includes various abbreviations as follows: “ACS” refers to the aluminum-containing species; “PC” refers to polymerizable component; “OC” refers to organophosphorus component; “BAEC” refers to brominated acrylate ester component; and “PI” refers to the photoinitiator. Moreover, “MA” refers to a (meth)acrylate; “IP” refers to isocyanurate polyacrylate; “PAI” refers to polyallyl isocyanurate; “OP” refers to an organophosphate; “TA” refers to trinol acrylate; and “TPO” refers to 2,4,6-trimethylbenzoyldiphenylphosphine oxide. Table 2 provides the amounts listed for a given composition provided in Table 1. Table 2 includes the same abbreviations included in Table 1. The amounts listed for a given composition are weight percents, based on the total weight of the composition. It is to be understood that all components of a given composition add up to 100 weight percent.

TABLE 1
Components for Example Compositions Using a Polymerizable Component.

| | Comp. | Comp. | Comp. | Comp. | Comp. | Comp. | Comp. | Comp. | Comp. |
|---|---|---|---|---|---|---|---|---|---|
| | 1 | 2 | 3 | 4 | 5 | 6 | 7 | 8 | 9 |
| ACS | Al(OH)₃ | Formula | Formula | Al(OH)₃ | Formula | Formula | Al(OH)₃ | Formula | Formula |
| | | I | II | | I | II | | I | II |
| PC | MA | MA | MA | IP | IP | IP | PAI | PAI | PAI |
| OC | OP | OP | OP | OP | OP | OP | OP | OP | OP |
| BAEC | TA | TA | TA | TA | TA | TA | TA | TA | TA |
| Formula | — | Formula | — | Formula | — | — | — | — | Formula |
| XX | | XX | | XX | | | | | XX |
| PI | TPO | TPO | TPO | TPO | TPO | TPO | TPO | TPO | TPO |

TABLE 2
Example Compositions Using a Polymerizable Component.

| | Comp. | Comp. | Comp. | Comp. | Comp. | Comp. | Comp. | Comp. | Comp. |
|---|---|---|---|---|---|---|---|---|---|
| | 1 | 2 | 3 | 4 | 5 | 6 | 7 | 8 | 9 |
| ACS | 8-10 | 2-4 | 6-8 | 6-8 | 8-10 | 8-10 | 8-10 | 6-8 | 2-4 |
| PC | 65-70 | 61-66 | 67-70 | 57-62 | 65-70 | 65-70 | 65-70 | 67-70 | 61-66 |
| OC | 10 | 10 | 10 | 10 | 10 | 10 | 10 | 10 | 10 |
| BAEC | 10 | 10 | 10 | 10 | 10 | 10 | 10 | 10 | 10 |
| Formula | — | 10 | — | 10 | — | — | — | — | 10 |
| XX | | | | | | | | | |
| PI | 2-5 | 2-5 | 2-5 | 2-5 | 2-5 | 2-5 | 2-5 | 2-5 | 2-5 |

Table 3 provides formulations of compositions for additive manufacturing according to some embodiments described herein, specifically example compositions using a polymerizable component and Formulas III-VI. In Table 3, “Comp.” means “Composition.” Table 3 includes various abbreviations as follows: “ACS” refers to the aluminum-containing species; “PC” refers to polymerizable component; “OC” refers to organophosphorus component; “BAEC” refers to brominated acrylate ester component; and “PI” refers to photoinitiator. Moreover, “MA” refers to a (meth)acrylate; “IP” refers to isocyanurate polyacrylate; “PAE” refers to polyallyl isocyanurate; “OP” refers to an organophosphate; “TA” refers to trinol acrylate; and “TPO” refers to 2,4,6-trimethylbenzoyldiphenylphosphine oxide. Table 4 provides the amounts listed for a given composition provided in Table 3. Table 4 includes the same abbreviations included in Table 3. The amounts listed for a given composition are weight percents, based on the total weight of the composition. It is to be understood that all components of a given composition add up to 100 weight percent.

TABLE 3
Components for Example Compositions Using a Polymerizable Component.

| | Comp. | Comp. | Comp. | Comp. | Comp. | Comp. | Comp. | Comp. |
|---|---|---|---|---|---|---|---|---|
| | 10 | 11 | 12 | 13 | 14 | 15 | 16 | 17 |
| ACS | Formula | Formula | Formula | Formula | Formula | Formula | Formula | Formula |
| | III | IV | V | VI | III | IV | V | VI |
| PC | MA | MA | MA | IP | IP | IP | PAI | PAI |
| OC | OP | OP | OP | OP | OP | OP | OP | OP |
| BAEC | TA | TA | TA | TA | TA | TA | TA | TA |
| Formula | — | Formula | — | Formula | — | — | — | Formula |
| XX | | XX | | XX | | | | XX |
| PI | TPO | TPO | TPO | TPO | TPO | TPO | TPO | TPO |

TABLE 4
Example Compositions Using a Polymerizable Component.

| | Comp. | Comp. | Comp. | Comp. | Comp. | Comp. | Comp. | Comp. |
|---|---|---|---|---|---|---|---|---|
| | 10 | 11 | 12 | 13 | 14 | 15 | 16 | 17 |
| ACS | 8-10 | 2-4 | 6-8 | 6-8 | 8-10 | 8-10 | 8-10 | 2-4 |
| PC | 65-70 | 61-66 | 67-70 | 57-62 | 65-70 | 65-70 | 65-70 | 61-66 |
| OC | 10 | 10 | 10 | 10 | 10 | 10 | 10 | 10 |
| BAEC | 10 | 10 | 10 | 10 | 10 | 10 | 10 | 10 |
| Formula | — | 10 | — | 10 | — | — | — | 10 |
| XX | | | | | | | | |
| PI | 2-5 | 2-5 | 2-5 | 2-5 | 2-5 | 2-5 | 2-5 | 2-5 |

Table 5 provides formulations of compositions for additive manufacturing according to some embodiments described herein, specifically examples using a sinterable powder. In Table 5, “Comp.” means “Composition.” Table 5 includes various abbreviations as follows: “ACS” refers to aluminum-containing species; “SP” refers to sinterable powder; “OC” refers to organophosphorus component; “MDC” refers to heptazine or melamine-derived component; “POC” refers to polymeric organobromine component; “BA” refers to a brominated polyacrylate; “EGC” refers to expandable graphite component; and “FA” refers to the flowing agent. Moreover, “PA11” refers to polyamide-11; “PA12” refers to polyamide-12; and “AE200” refers to Aerosil 200.

Table 6 provides the amounts listed for a given composition provided in Table 5. Table 6 includes the same abbreviations included in Table 5. The amounts listed for a given composition are weight percents, based on the total weight of the composition. It is to be understood that all components of a given composition add up to 100 weight percent.

TABLE 5
Components for Example Compositions Using a Sinterable Powder.

| | Comp. | Comp. | Comp. | Comp. | Comp. | Comp. | Comp. | Comp. | Comp. |
|---|---|---|---|---|---|---|---|---|---|
| | 18 | 19 | 20 | 21 | 22 | 23 | 24 | 25 | 26 |
| ACS | Al(OH)₃ | Formula | Formula | Al(OH)₃ | Formula | Formula | Al(OH)₃ | Formula | Formula |
| | | I | II | | I | II | | I | II |
| SP | PA11 | PA11 | PA11 | PA12 | PA12 | PA12 | PA11 + | PA11 + | PA11 + |
| | | | | | | | PA12 | PA12 | PA12 |
| OC | OP | OP | OP | OP | OP | OP | OP | OP | OP |
| MDC | Formula | — | Formula | — | Formula | — | Formula | — | Formula |
| | XXII | | XXII | | XXII | | XXII | | XXII |
| POC | — | BA | — | BA | — | BA | — | BA | — |
| EGC | — | EGC | EGC | EGC | EGC | — | EGC | — | EGC |
| FA | AE200 | AE200 | AE200 | AE200 | AE200 | AE200 | AE200 | AE200 | AE200 |

TABLE 6
Example Compositions Using a Sinterable Powder.

| | Comp. | Comp. | Comp. | Comp. | Comp. | Comp. | Comp. | Comp. | Comp. |
|---|---|---|---|---|---|---|---|---|---|
| | 18 | 19 | 20 | 21 | 22 | 23 | 24 | 25 | 26 |
| ACS | 2 | 2 | 2 | 4 | 4 | 4 | 6 | 6 | 6 |
| SP | 82.9 | 72.9 | 72.9 | 70.9 | 70.9 | 80.9 | 68.9 | 78.9 | 68.9 |
| OC | 10 | 10 | 10 | 10 | 10 | 10 | 10 | 10 | 10 |
| MDC | 5 | — | 5 | — | 5 | — | 5 | — | 5 |
| POC | — | 5 | — | 5 | — | 5 | — | 5 | — |
| EGC | — | 10 | 10 | 10 | 10 | — | 10 | — | 10 |
| FA | 0.1 | 0.1 | 0.1 | 0.1 | 0.1 | 0.1 | 0.1 | 0.1 | 0.1 |

Table 7 provides formulations of compositions for additive manufacturing according to some embodiments described herein, specifically examples using a sinterable powder and Formulas III-VI. In Table 7, “Comp.” means “Composition.” Table 5 includes various abbreviations as follows: “ACS” refers to aluminum-containing species; “SP” refers to sinterable powder; “OC” refers to organophosphorus component; “MDC” refers to heptazine or melamine-derived component; “POC” refers to polymeric organobromine component; “BA” refers to brominated polyacrylate; “EGC” refers to expandable graphite component; and “FA” refers to flowing agent. Moreover, “PA11” refers to polyamide-11; “PA12” refers to polyamide-12; and “AE200” refers to Aerosil 200.

Table 8 provides the amounts listed for a given composition provided in Table 57. Table 8 includes the same abbreviations included in Table 7. The amounts listed for a given composition are weight percents, based on the total weight of the composition. It is to be understood that all components of a given composition add up to 100 weight percent.

TABLE 7
Components for Example Compositions Using a Sinterable Powder.

| | Comp. | Comp. | Comp. | Comp. | Comp. | Comp. | Comp. | Comp. |
|---|---|---|---|---|---|---|---|---|
| | 27 | 28 | 29 | 30 | 31 | 32 | 33 | 34 |
| ACS | Formula | Formula | Formula | Formula | Formula | Formula | Formula | Formula |
| | III | IV | V | VI | III | IV | V | VI |
| SP | PA11 | PA11 | PA11 | PA12 | PA12 | PA12 | PA11 + | PA11 + |
| | | | | | | | PA12 | PA12 |
| OC | OP | OP | OP | OP | OP | OP | OP | OP |
| MDC | Formula | — | Formula | — | Formula | — | Formula | — |
| | XXII | | XXII | | XXII | | XXII | |
| POC | — | BA | — | BA | — | BA | — | BA |
| EGC | — | EGC | EGC | EGC | EGC | — | EGC | — |
| FA | AE200 | AE200 | AE200 | AE200 | AE200 | AE200 | AE200 | AE200 |

TABLE 8
Example Compositions Using a Sinterable Powder.

| | Comp. | Comp. | Comp. | Comp. | Comp. | Comp. | Comp. | Comp. |
|---|---|---|---|---|---|---|---|---|
| | 27 | 28 | 29 | 30 | 31 | 32 | 33 | 34 |
| ACS | 2 | 2 | 2 | 4 | 4 | 4 | 6 | 6 |
| SP | 82.9 | 72.9 | 72.9 | 70.9 | 70.9 | 80.9 | 68.9 | 78.9 |
| OC | 10 | 10 | 10 | 10 | 10 | 10 | 10 | 10 |
| MDC | 5 | — | 5 | — | 5 | — | 5 | — |
| POC | — | 5 | — | 5 | — | 5 | — | 5 |
| EGC | — | 10 | 10 | 10 | 10 | — | 10 | — |
| FA | 0.1 | 0.1 | 0.1 | 0.1 | 0.1 | 0.1 | 0.1 | 0.1 |

Table 9 provides formulations of compositions for additive manufacturing according to some embodiments described herein, specifically example using a thermoplastic polymer. In Table 9, “Comp.” means “Composition.” Table 9 includes various abbreviations as follows: “ACS” refers to aluminum-containing species; “TP” refers to thermoplastic polymer; “OC” refers to the organophosphorus component; “MDC” refers to heptazine or melamine-derived component; “POC” refers to the polymeric organobromine component; “BA” refers to brominated polyacrylate; “EGC” refers to expandable graphite component; and “FA” refers to flowing agent. Moreover, “ABS” refers to acrylonitrile butadiene styrene; “PLA” refers to polylactic acid; “TPU” refers to thermoplastic polyurethane; and “AE200” refers to Aerosil 200.

Table 10 provides the amounts listed for a given composition provided in Table 9. Table 10 includes the same abbreviations included in Table 9. The amounts listed for a given composition are weight percents, based on the total weight of the composition. It is to be understood that all components of a given composition add up to 100 weight percent.

TABLE 9
Components for Example Compositions Using a Thermoplastic Polymer.

| | Comp. | Comp. | Comp. | Comp. | Comp. | Comp. | Comp. | Comp. | Comp. |
|---|---|---|---|---|---|---|---|---|---|
| | 35 | 36 | 37 | 38 | 39 | 40 | 41 | 42 | 43 |
| ACS | Al(OH)₃ | Formula | Formula | Al(OH)₃ | Formula | Formula | Al(OH)₃ | Formula | Formula |
| | | I | II | | I | II | | I | II |
| TP | ABS | ABS | ABS | PLA | PLA | PLA | TPU | TPU | TPU |
| OC | OP | OP | OP | OP | OP | OP | OP | OP | OP |
| MDC | Formula | — | Formula | — | Formula | — | Formula | — | Formula |
| | XIII | | XIII | | XIII | | XIII | | XIII |
| POC | — | BA | — | BA | — | BA | — | BA | — |
| EGC | — | EGC | EGC | EGC | EGC | — | EGC | — | EGC |
| FA | AE200 | AE200 | AE200 | AE200 | AE200 | AE200 | AE200 | AE200 | AE200 |

TABLE 10
Example Compositions Using a Thermoplastic Polymer.

| | Comp. | Comp. | Comp. | Comp. | Comp. | Comp. | Comp. | Comp. | Comp. |
|---|---|---|---|---|---|---|---|---|---|
| | 35 | 36 | 37 | 38 | 39 | 40 | 41 | 42 | 43 |
| ACS | 2 | 2 | 2 | 4 | 4 | 4 | 6 | 6 | 6 |
| TP | 82.9 | 72.9 | 72.9 | 70.9 | 70.9 | 80.9 | 68.9 | 78.9 | 68.9 |
| OC | 10 | 10 | 10 | 10 | 10 | 10 | 10 | 10 | 10 |
| MDC | 5 | — | 5 | — | 5 | — | 5 | — | 5 |
| POC | — | 5 | — | 5 | — | 5 | — | 5 | — |
| EGC | — | 10 | 10 | 10 | 10 | — | 10 | — | 10 |
| FA | 0.1 | 0.1 | 0.1 | 0.1 | 0.1 | 0.1 | 0.1 | 0.1 | 0.1 |

Table 11 provides formulations of compositions for additive manufacturing according to some embodiments described herein, specifically example using a thermoplastic polymer and Formulas III-VI. In Table 11, “Comp.” means “Composition.” Table 9 includes various abbreviations as follows: “ACS” refers to aluminum-containing species; “TP” refers to thermoplastic polymer; “OC” refers to organophosphorus component; “MDC” refers to heptazine or melamine-derived component; “POC” refers to polymeric organobromine component; “BA” refers to brominated polyacrylate; “EGC” refers to expandable graphite component; and “FA” refers to flowing agent. Moreover, “ABS” refers to acrylonitrile butadiene styrene; “PLA” refers to polylactic acid; “TPU” refers to thermoplastic polyurethane; and “AE200” refers to Aerosil 200.

Table 12 provides the amounts listed for a given composition provided in Table 11. Table 12 includes the same abbreviations included in Table 11. The amounts listed for a given composition are weight percents, based on the total weight of the composition. It is to be understood that all components of a given composition add up to 100 weight percent.

TABLE 11
Components for Example Compositions Using a Thermoplastic Polymer.

| | Comp. | Comp. | Comp. | Comp. | Comp. | Comp. | Comp. | Comp. |
|---|---|---|---|---|---|---|---|---|
| | 44 | 45 | 46 | 47 | 48 | 49 | 50 | 51 |
| ACS | Formula | Formula | Formula | Formula | Formula | Formula | Formula | Formula |
| | III | IV | V | VI | III | IV | V | VI |
| TP | ABS | ABS | ABS | PLA | PLA | PLA | TPU | TPU |
| OC | OP | OP | OP | OP | OP | OP | OP | OP |
| MDC | Formula | — | Formula | — | Formula | — | Formula | — |
| | XIII | | XIII | | XIII | | XIII | |
| POC | — | BA | — | BA | — | BA | — | BA |
| EGC | — | EGC | EGC | EGC | EGC | — | EGC | — |
| FA | AE200 | AE200 | AE200 | AE200 | AE200 | AE200 | AE200 | AE200 |

TABLE 12
Example Compositions Using a Thermoplastic Polymer.

| | Comp. | Comp. | Comp. | Comp. | Comp. | Comp. | Comp. | Comp. |
|---|---|---|---|---|---|---|---|---|
| | 44 | 45 | 46 | 47 | 48 | 49 | 50 | 51 |
| ACS | 2 | 2 | 2 | 4 | 4 | 4 | 6 | 6 |
| TP | 82.9 | 72.9 | 72.9 | 70.9 | 70.9 | 80.9 | 68.9 | 78.9 |
| OC | 10 | 10 | 10 | 10 | 10 | 10 | 10 | 10 |
| MDC | 5 | — | 5 | — | 5 | — | 5 | — |
| POC | — | 5 | — | 5 | — | 5 | — | 5 |
| EGC | — | 10 | 10 | 10 | 10 | — | 10 | — |
| FA | 0.1 | 0.1 | 0.1 | 0.1 | 0.1 | 0.1 | 0.1 | 0.1 |

Table 13 provides information about components of compositions for additive manufacturing according to some embodiments described herein, specifically compositions using a polymerizable component and Al(OH)₃. Comparative compositions that do not comprise Al(OH)₃ are also shown as Comparative Compositions 1 and 2. In Table 13, “Comp.” means “Composition.” Table 13 includes various abbreviations as follows: “ACS” refers to the aluminum-containing species; “PC” refers to polymerizable components; “MAO” refers to a (meth)acrylate oligomer; “MAM” refers to (meth)acrylate monomer; “CP” refers to coreshell particles; “AFRA” refers to additional fire resistant additives; “OC” refers to organophosphorus component; “BAEC” refers to brominated acrylate ester component; “OA” refers to optical additives, including photoinitiator (“PI”), colorant (“CL”), and non-curable absorber (“NCA”); and “SA” refers to stabilizing additives, including dispersants (“DT”) and anti-settling agents (“ASA”). Table 14 provides the amounts listed for a given composition provided in Table 13. Table 14 includes the same abbreviations included in Table 13. The amounts listed for a given composition are weight percents, based on the total weight of the composition. It is to be understood that all components of a given composition add up to 100 weight percent.

TABLE 13
Components for Comparative Compositions 1 and 2 and Compositions 52-56.

| | Comparative | Comparative | Comp. | Comp. | Comp. | Comp. | Comp. |
|---|---|---|---|---|---|---|---|
| | Comp. 1 | Comp. 2 | 52 | 53 | 54 | 55 | 56 |
| ACS | — | — | Al(OH)₃ | Al(OH)₃ | Al(OH)₃ | Al(OH)₃ | Al(OH)₃ |
| PC | MAO + | MAO + | MAO + | MAO + | MAO + | MAO + | MAO + |
| | MAM + | MAM + | MAM + | MAM + | MAM + | MAM + | MAM + |
| | Formula | Formula | Formula | Formula | Formula | Formula | Formula |
| | VIII | VIII | VIII | VIII | VIII | VIII | VIII |
| CP | CP | — | CP | — | CP | CP | CP |
| AFRA | OC + | OC + | OC + | OC + | OC + | OC + | OC + |
| | BAEC | BAEC | BAEC | BAEC | BAEC | BAEC | BAEC |
| OA + SA | PI + CL + | PI + CL + | PI + CL + | PI + CL + | PI + | PI + | PI + |
| | NCA + | NCA + | NCA + | NCA + | NCA + | NCA + | NCA + |
| | DT + ASA | DT + ASA | DT + ASA | DT + ASA | DT + ASA | DT + ASA | DT + ASA |

TABLE 14
Formulations for Comparative Compositions 1 and 2 and Compositions 52-56.

| | Comparative | Comparative | Comp. | Comp. | Comp. | Comp. | Comp. |
|---|---|---|---|---|---|---|---|
| | Comp. 1 | Comp. 2 | 52 | 53 | 54 | 55 | 56 |
| ACS | 0 | 0 | 10 | 10 | 10 | 10 | 12 |
| PC | 70.46 | 75.98 | 62.22 | 67.01 | 62.22 | 62.43 | 61.16 |
| CP | 7.25 | 0 | 6.4 | 0 | 6.4 | 6.43 | 6.3 |
| AFRA | 19.69 | 21.23 | 17.38 | 19 | 17.38 | 17.44 | 17.09 |
| OA + SA | 2.59 | 2.80 | 3.99 | 3.99 | 3.99 | 3.7 | 3.45 |

Table 15 provides the physical properties of 3D articles printed using Comparative Compositions 1 and 2 and Compositions 52-56. HDT was measured using DMA at 0.455 MPa according to ASTM D648. Flexural modulus and flexural strength were measured according to ASTM D790. Elastic modulus, elongation at break, and tensile strength were measured according to ASTM D638. Moreover, the viscosity was also measured. Viscosity measurements were taken using a Brookfield viscometer model RVDVE-HA with a SC4-21 spindle and SC4-13R cup. A sample volume of 7.2 mL was placed in the cup of the viscometer, and the spindle was lowered into the cup where the spindle speed was set to 50 rpm. The cup was a jacketed cup connected to a water circulating bath set to maintain a sample temperature of 30° C. The sample was allowed to come to temperature for 10-20 minutes before the reading was taken.

TABLE 15
Physical Properties of Comparative Compositions 1 and 2 and Compositions 52-56.

| | Comparative | Comparative | Comp. | Comp. | Comp. | Comp. | Comp. |
|---|---|---|---|---|---|---|---|
| | Comp. 1 | Comp. 2 | 52 | 53 | 54 | 55 | 56 |
| 0.455 MPa | — | — | 114.1 | 115.9 | — | — | — |
| HDT (° C.) | | | | | | | |
| 1.82 MPa | — | — | 93.0 | 90.8 | — | — | — |
| HDT (° C.) | | | | | | | |
| Flexural Modulus | — | — | 3461 | 3709 | — | — | — |
| Flexural Strength | — | — | 97.2 | 108.7 | — | — | — |
| Elastic Modulus | 3315 | 3641 | 4174 | 3916 | 3879 | 3424 | 4064 |
| Elongation (%) | 4.6 | 3.5 | 4.0 | 3.3 | 4.1 | 4.3 | 3.4 |
| at Break | | | | | | | |
| Tensile Strength | 78.2 | 80.7 | 65.8 | 68.2 | 64.5 | 65.1 | 61.0 |
| (MPa) | | | | | | | |
| Viscosity (cPs) | — | — | 944 | 930 | — | 914 | 876 |

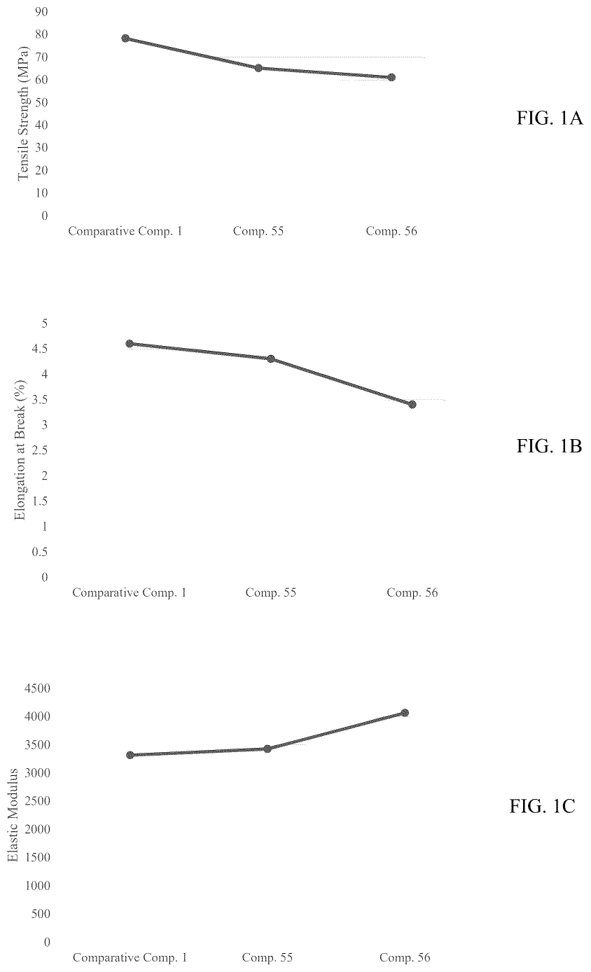

As can be seen with Compositions 55 and 56, as compared to Comparative Composition 1, with the addition of Al(OH)₃, the elastic modulus increased. Values for the tensile strength, elongation at break, and elastic modulus for these compositions are plotted in FIGS. 1A-C.

Additionally, flammability testing was conducted for Comparative Compositions 1 and 2 and Compositions 53-56. Flammability testing was done according to the UL94 vertical burn test. Comparative Compositions 1 and 2 and Compositions 55 and 56 were tested at 90 minutes-post cure. Compositions 53 and 54 were tested at 180 minutes-post cure. The results are shown in Tables 16 and 17. Data are shown as the average flame time in seconds(s). The nominal thickness of the sample strips was in the range of 0.8-0.9 mm. The sample size was 5 samples.

TABLE 16
Flammability Testing Results.

| | Flame Time (s) |
|---|---|
| Comparative Comp. 1 | 17 |
| Comp. 54 | 10.4 |
| Comp. 55 | 14.4 |
| Comp. 56 | 10 |

TABLE 17
Flammability Testing Results.

| | Flame Time (s) |
|---|---|
| Comparative Comp. 2 | 10 |
| Comp. 53 | 5.6 |

For the flammability testing, reduced average flame times generally indicate better performance. As compared to Comparative Composition 1, Compositions 54, 55, and 56 showed reduced average flame times (improved flammability performance). Moreover, as compared to Comparative Composition 2, Composition 53 showed a reduced average flame time (improved flammability performance).

Some additional non-limiting example Embodiments are below:

Embodiment 1. A composition for additive manufacturing comprising:

an aluminum-containing species in an amount of up to 20 wt. %, based on the total weight of the composition.

Embodiment 2. The composition of Embodiment 1, wherein the aluminum-containing species comprises Al(OH)₃.

Embodiment 3. The composition of Embodiment 1, wherein the aluminum-containing species comprises a species of Formula I or Formula II:

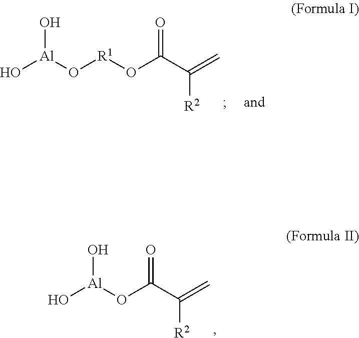

wherein R¹ is C1-C10 alkyl or alkylene (e.g., CH₂) and R² is H or CH₃.

Embodiment 4. The composition of Embodiment 1, wherein the aluminum-containing species comprises Al₂O₃.

Embodiment 5. The composition of Embodiment 4, wherein the Al₂O₃ is functionalized with one or more polymerizable groups.

Embodiment 6. The composition of any of the preceding Embodiments, further comprising a polymerizable component.

Embodiment 7. The composition of Embodiment 6, wherein the polymerizable component is a (meth)acrylate component.

Embodiment 8. The composition of Embodiment 7, wherein the (meth)acrylate component is present in an amount of 30-70 wt. %, based on total weight of the composition.

Embodiment 9. The composition of Embodiment 7 or Embodiment 8, wherein the (meth)acrylate component comprises a mixture of (meth)acrylate monomer and (meth)acrylate oligomer.

Embodiment 10. The composition of Embodiment 6, wherein the polymerizable component is a curable isocyanurate component.

Embodiment 11. The composition of Embodiment 10, wherein the curable isocyanurate component comprises isocyanurate polyacrylate, polyallyl isocyanurate, or a mixture thereof.

Embodiment 12. The composition of Embodiment 11, wherein the curable isocyanurate comprises isocyanurate polyacrylate, and the isocyanurate polyacrylate is of Formula IX:

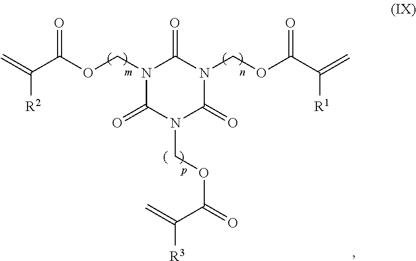

wherein R³-R⁵ are each independently selected from the group consisting of hydrogen and alkyl and m, n, and p are each integers independently ranging from 1 to 10.

Embodiment 13. The composition of Embodiment 11, wherein the curable isocyanurate comprises polyallyl isocyanurate, and the polyallyl isocyanurate is of Formula X:

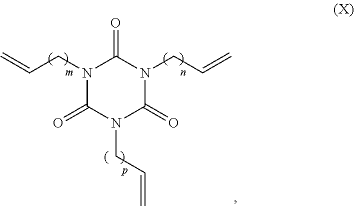

wherein m, n, and p are integers independently ranging from 1 to 10.

Embodiment 14. The composition of any of Embodiments 10-13, wherein the curable isocyanurate component is present in an amount of 30-80 wt. %, based on total weight of the composition.

Embodiment 15. The composition of any of the preceding Embodiments, wherein the composition further comprises an organophosphorus component comprising one or more organophosphorus compounds.

Embodiment 16. The composition of Embodiment 15, wherein the one or more organophosphorous compounds comprises one or more organophosphate compounds.

Embodiment 17. The composition of Embodiment 16, wherein the one or more organophosphate compounds are of Formula XI:

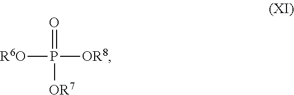

wherein R⁶-R⁸ are each independently selected from the group consisting of hydrogen, alkyl, alkenyl, alkynyl, cycloalkyl, heteroalkyl, heteroalkenyl, heterocyclyl, aryl, heteroaryl, and (meth)acryloyl.

Embodiment 18. The composition of Embodiment 16, wherein the one or more organophosphate compounds comprise a bis(organophosphate).

Embodiment 19. The composition of Embodiment 16, wherein the one or more organophosphorous compounds comprises a phosphinate component.

Embodiment 20. The composition of Embodiment 19, wherein the phosphinate component comprises a species of Formula XII or Formula XIII:

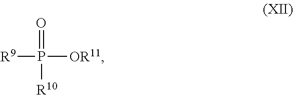

wherein R⁹, R¹⁰, and R¹¹ are each independently selected from the group consisting of hydrogen, alkyl, alkenyl, alkynyl, cycloalkyl, heteroalkyl, heteroalkenyl, heterocyclyl, aryl, and heteroaryl; and

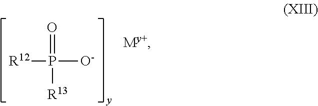

wherein R¹² and R¹³ are each independently selected from the group consisting of hydrogen, alkyl, alkenyl, alkynyl, cycloalkyl, heteroalkyl, heteroalkenyl, heterocyclyl, aryl, and heteroaryl; M is a metal; and
y is an integer ranging from 1 to 3.

Embodiment 21. The composition of Embodiment 16, wherein the one or more organophosphate compounds comprises a urethane (meth)acrylate moiety.

Embodiment 22. The composition of Embodiment 15, wherein the one or more organophosphorous compounds comprises a phosphonate.

Embodiment 23. The composition of Embodiment 22, wherein the phosphonate component comprises a species of Formula XIV or Formula XV:

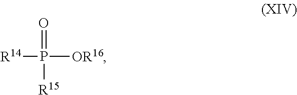

wherein R¹⁴, R¹⁵, and R¹⁶ are each independently selected from the group consisting of hydrogen, alkyl, alkenyl, alkynyl, cycloalkyl, heteroalkyl, heteroalkenyl, heterocyclyl, aryl, and heteroaryl; and

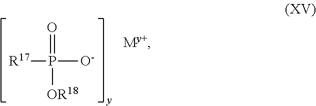

wherein R¹⁷ and R¹⁸ are each independently selected from the group consisting of hydrogen, alkyl, alkenyl, alkynyl, cycloalkyl, heteroalkyl, heteroalkenyl, heterocyclyl, aryl, and heteroaryl; M is a metal; and
y is an integer ranging from 1 to 3.

Embodiment 24. The composition of Embodiment 22, wherein the phosphonate component comprises a species of Formula XVI:

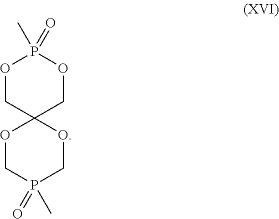

Embodiment 25. The composition of Embodiment 15, wherein the one or more organophosphorus compounds comprises a species of Formula XVII:

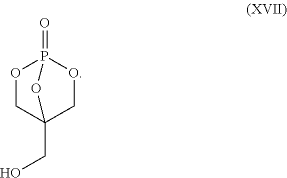

Embodiment 26. The composition of any of Embodiments 15-25, wherein the organophosphorous component is present in an amount of 10-40 wt. %, based on total weight of the composition.

Embodiment 27. The composition of any of the preceding Embodiments, further comprising a brominated acrylate ester component.

Embodiment 28. The composition of Embodiment 27, wherein the brominated acrylate ester component comprises one or more compounds of Formula XVIII:

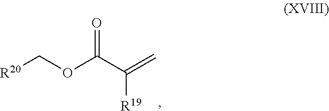

wherein R¹⁹ is selected from the group consisting of hydrogen and methyl, and wherein R²⁰ is selected from the groups consisting of brominated alkyl and brominated alkenyl.

Embodiment 29. The composition of Embodiment 27, wherein the brominated acrylate ester component comprises trinol acrylate.

Embodiment 30. The composition of any of Embodiments 27-29, wherein the brominated acrylate ester component is present in an amount of 10-40 wt. %, based on total weight of the composition.

Embodiment 31. The composition of any of Embodiments 1-30, further comprising an additive of Formula XXa:

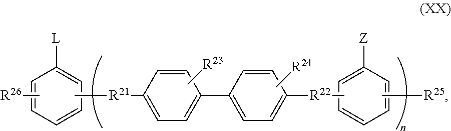

wherein L and Z are ring substituents comprising at least one polymerizable point of unsaturation, and wherein R²¹ and R²² are alkylene, and R²³-R²⁶ each represent one to four optional ring substituents, each one of the one to four ring substituents independently selected from the group consisting of alkyl, heteroalkyl, haloalkyl, halo, hydroxyl, alkoxy, amine, amide, and ether, and wherein x is an integer from 1 to 7.

Embodiment 32. The composition of any of Embodiments 1-30, further comprising an additive of Formula XXb:

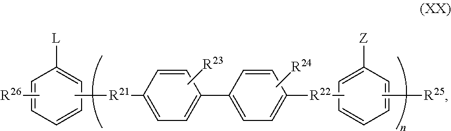

wherein L and Z are ring substituents comprising at least one polymerizable point of unsaturation, and wherein R²¹ and R²² are independently selected from the group consisting of alkylene and alkenylene, and R²³-R²⁶ each represent one to four optional ring substituents, each one of the one to four ring substituents independently selected from the group consisting of alkyl, heteroalkyl, haloalkyl, halo, hydroxyl, alkoxy, amine, amide, and ether, and wherein x is an integer from 1 to 7, and wherein L and Z each comprise a cyclopolymerizable functionality.

Embodiment 33. The composition of Embodiment 32, wherein the cyclopolymerizable functionality is of the formula:

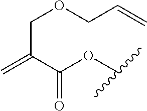 [SMILES: *OC(=O)C(=C)COCC=C]

where [symbol] is an attachment point of the cyclopolymerizable functionality to the compound of Formula XXb.

Embodiment 34. The composition of any of Embodiments 1-30, further comprising an additive of Formula XXc:

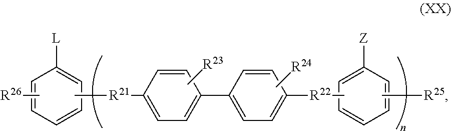

wherein L and Z are ring substituents comprising at least one polymerizable point of unsaturation, and wherein R²¹ and R²² are independently selected from the group consisting of alkylene and alkenylene, and R²³-R²⁶ each represent one to four optional ring substituents, each one of the one to four ring substituents independently selected from the group consisting of alkyl, heteroalkyl, haloalkyl, halo, hydroxyl, alkoxy, amine, amide, and ether, and wherein x is 2 or 3.

Embodiment 35. The composition of any of Embodiments 1-30, further comprising an additive of Formula XXd:

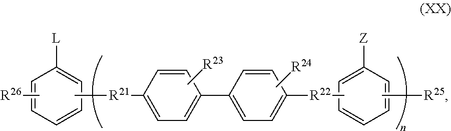

wherein L and Z are ring substituents comprising at least one polymerizable point of unsaturation, and wherein R²¹ and R²² are independently selected from the group consisting of alkylene and alkenylene, and R²³-R²⁶ each represent one to four optional ring substituents, each one of the one to four ring substituents independently selected from the group consisting of alkyl, heteroalkyl, haloalkyl, halo, hydroxyl, alkoxy, amine, amide, and ether, wherein x is an integer from 1 to 7, and wherein L and Z each comprise an acrylate moiety.

Embodiment 36. The composition of any of Embodiments 1-30, further comprising an additive of Formula XXe:

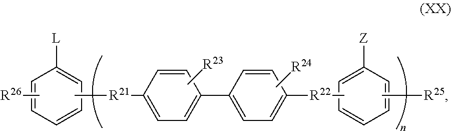

wherein L and Z are ring substituents comprising at least one polymerizable point of unsaturation, and wherein R²¹ and R²² are each independently selected from the group consisting of alkylene and alkenylene, and R²³-R²⁶ each represent one to four optional ring substituents, each one of the one to four ring substituents independently selected from the group consisting of alkyl, heteroalkyl, haloalkyl, halo, hydroxyl, alkoxy, amine, amide, and ether, wherein x is an integer from 1 to 7, and wherein L and Z each comprise a methacrylate moiety.

Embodiment 37. The composition of any of Embodiments 1-36, wherein the composition, when cured, passes FAR 25.853 (60 second and 12 second), and has a Tensile Strength (TS) Ratio of at least 1.0.

Embodiment 38. A method of printing a three-dimensional article comprising: providing a composition comprising the composition of any of Embodiments 1-37; and selectively curing a portion of the composition.

Embodiment 39. The method of Embodiment 38, wherein the composition is provided in a layer-by-layer process.

Embodiment 40. The method of Embodiment 38 or Embodiment 39, wherein curing comprises photocuring.

Embodiment 41. The method of any of Embodiments 38-40, wherein:
the article passes FAR 25.853 (60 second and 12 second); and
the article a Tensile Strength (TS) Ratio of at least 1.0.

Embodiment 42. The method of Embodiment 41, wherein the article has a Tensile Strength (TS) Ratio of greater than 1.0.

Embodiment 43. The method of any of Embodiments 38-42, wherein the article has a limiting oxygen index of 25-30% according to ISO 4589.

Embodiment 44. The method of any of Embodiments 38-42, wherein the article has a limiting oxygen index of 28-30% according to ISO 4589.

Embodiment 45. The method of any of Embodiments 38-44, wherein the article has a v0 rating according to UL 94V.

Embodiment 46. The method of any of Embodiments 38-44, wherein the article has a v1 rating according to UL 94V.

Embodiment 47. A composition for additive manufacturing comprising:
a sinterable powder in an amount of 10-99 wt. %, based on the total weight of the composition; and
an aluminum-containing species in an amount of up to 20 wt. %, based on the total weight of the composition.

Embodiment 48. The composition of Embodiment 47, wherein the aluminum-containing species comprises Al(OH)₃.

Embodiment 49. The composition of Embodiment 47, wherein the aluminum-containing species comprises a species of Formula I or Formula II:

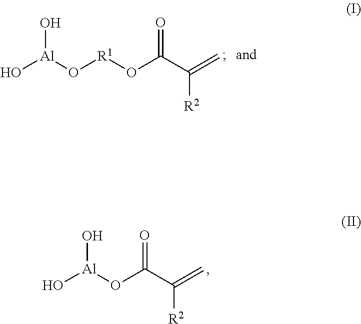

wherein R¹ is C1-C10 alkyl or alkylene (e.g., CH₂) and R² is H or CH₃.

Embodiment 50. The composition of Embodiment 47, wherein the aluminum-containing species comprises Al₂O₃.

Embodiment 51. The composition of Embodiment 50, wherein the Al₂O₃ is functionalized with one or more polymerizable groups.

Embodiment 52. The composition of any of Embodiments 47-51, further comprising an organophosphorus component comprising one or more organophosphorus compounds.

Embodiment 53. The composition of Embodiment 52, wherein the one or more organophosphorous compounds comprises one or more organophosphate compounds.

Embodiment 54. The composition of Embodiment 53, wherein the one or more organophosphate compounds are of Formula XI:

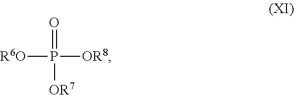

wherein R⁶-R⁸ are independently selected from the group consisting of hydrogen, alkyl, alkenyl, alkynyl, cycloalkyl, heteroalkyl, heteroalkenyl, heterocyclyl, aryl, heteroaryl, and (meth)acryloyl.

Embodiment 55. The composition of Embodiment 53, wherein the one or more organophosphate compounds comprise bis(organophosphate).

Embodiment 56. The composition of Embodiment 52, wherein the organophosphorus component comprises a phosphinate component.

Embodiment 57. The composition of Embodiment 56, wherein the phosphinate component comprises a species of Formula XII or Formula XIII:

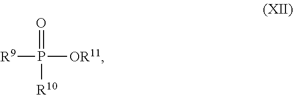

wherein R⁹, R¹⁰, and R¹⁹ are each independently selected from the group consisting of hydrogen, alkyl, alkenyl, alkynyl, cycloalkyl, heteroalkyl, heteroalkenyl, heterocyclyl, aryl, and heteroaryl; and

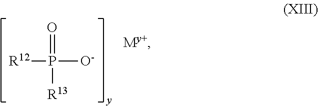

wherein R¹² and R¹³ are each independently selected from the group consisting of hydrogen, alkyl, alkenyl, alkynyl, cycloalkyl, heteroalkyl, heteroalkenyl, heterocyclyl, aryl, and heteroaryl; M is a metal; and
y is an integer ranging from 1 to 3.

Embodiment 58. The composition of Embodiment 53, wherein the one or more organophosphate compounds comprises a urethane (meth)acrylate moiety.

Embodiment 59. The composition of Embodiment 52, wherein the organophosphorus component comprises a phosphonate.

Embodiment 60. The composition of Embodiment 59, wherein the phosphonate component comprises a species of Formula XIV or Formula XV:

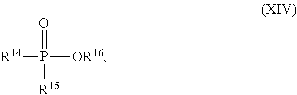

wherein R¹⁴, R¹⁵, and R¹⁶ are each independently selected from the group consisting of hydrogen, alkyl, alkenyl, alkynyl, cycloalkyl, heteroalkyl, heteroalkenyl, heterocyclyl, aryl, and heteroaryl; and

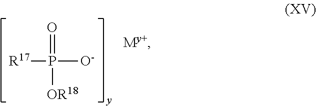

wherein R¹⁷ and R¹⁸ are each independently selected from the group consisting of hydrogen, alkyl, alkenyl, alkynyl, cycloalkyl, heteroalkyl, heteroalkenyl, heterocyclyl, aryl, and heteroaryl; M is a metal; and
y is an integer ranging from 1 to 3.

Embodiment 61. The composition of Embodiment 59, wherein the phosphonate component comprises a species of Formula XVI:

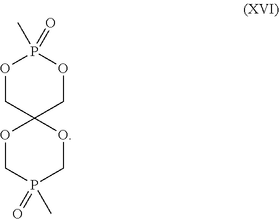

Embodiment 62. The composition of Embodiment 52, wherein the one or more organophosphorus compounds comprises a species of Formula XVII:

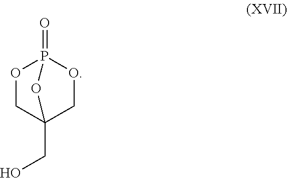

Embodiment 63. The composition of any of Embodiments 52-62, wherein the organophosphorous component is present in an amount of 10-40 wt. %, based on total weight of the composition.

Embodiment 64. The composition of any of Embodiments 47-63, further comprising a heptazine or melamine-derived component.

Embodiment 65. The composition of Embodiment 64, wherein the heptazine or melamine-derived component comprises a species of Formula XXI:

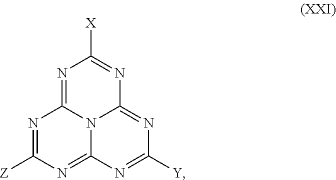

wherein X, Y, and Z are each independently selected from H and NR²⁷R²⁸,
wherein R²⁷ and R²⁸ are each independently selected from H and a C1-C5 alkyl.

Embodiment 66. The composition of Embodiment 64, wherein the heptazine or melamine-derived component comprises a species of Formula XXII:

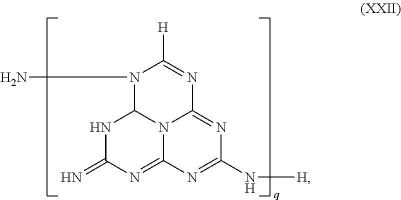

wherein q is an integer from 2 to 1000.

Embodiment 67. The composition of Embodiment 64, wherein the heptazine or melamine-derived component comprises a species of Formula XXIII:

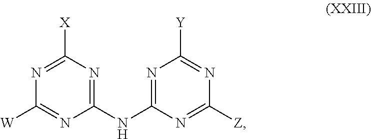

wherein W, X, Y, and Z are each independently selected from H and NR²⁷R²⁸,
wherein R²⁷ and R²⁸ are each independently selected from H and a C1-C5 alkyl.

Embodiment 68. The composition of Embodiment 64, wherein the heptazine or melamine-derived component comprises a heptazine or melamine-derived oligomer.

Embodiment 69. The composition of Embodiment 64, wherein the heptazine or melamine-derived component comprises g-C₃N₄.

Embodiment 70. The composition of Embodiment 64, wherein the heptazine or melamine-derived component does not comprise melamine.

Embodiment 71. The composition of any of Embodiments 47-70, further comprising a polymeric organobromine component.

Embodiment 72. The composition of Embodiment 71, wherein the polymeric organobromine component comprises a brominated polystyrene, a brominated polyacrylate, a brominated epoxy, an end-capped brominated epoxy, or a combination of two or more of the foregoing.

Embodiment 73. The composition of any of Embodiments 47-72, further comprising an expandable graphite component.

Embodiment 74. The composition of any of Embodiments 47-52, 56, 57, or 59-73, wherein the composition is free or substantially free of phosphate.

Embodiment 75. The composition of any of Embodiments 47-74, wherein the sinterable powder comprises a semicrystalline polymer.

Embodiment 76. The composition of Embodiment 75, wherein the sinterable powder comprises a polyamide (PA), a polyester (PEs), a polyurethane (PU), a polyethyelene (PE), a polypropylene (PP), a poly(butylene terephthalate) (PBT), a poly(etheretherketone) (PEEK), a poly(etherketoneketone) (PEKK), or a combination of two or more of the foregoing.

Embodiment 77. The composition of any of Embodiments 47-76, wherein the composition, when sintered, passes FAR 25.853 (60 second and 12 second), and has a Tensile Strength (TS) Ratio of at least 1.0.

Embodiment 78. A method of printing a three-dimensional article comprising:
providing a composition according to any of Embodiments 47-77; and
selectively solidifying layers of the composition to form the article.

Embodiment 79. The method of Embodiment 78, wherein the composition is provided in a layer-by-layer process.

Embodiment 80. The method of Embodiment 77 or Embodiment 78, wherein:
the article passes FAR 25.853 (60 second and 12 second); and the article has a Tensile Strength (TS) Ratio of at least 1.0.

Embodiment 81. The method of Embodiment 80, wherein the article has a Tensile Strength (TS) Ratio of greater than 1.0.

Embodiment 82. The method of any of Embodiments 78-81, wherein the article has a limiting oxygen index of 25-30% according to ISO 4589.

Embodiment 83. The method of Embodiment 82, wherein the article has a limiting oxygen index of 28-30% according to ISO 4589.

Embodiment 84. The method of any of Embodiments 78-83, wherein the article has a v0 rating according to UL 94V.

Embodiment 85. The method of any of Embodiments 78-83, wherein the article has a v1 rating according to UL 94V.

Embodiment 86. A composition for additive manufacturing comprising:
a thermoplastic polymer in an amount of 10-99 wt. %, based on the total weight of the composition; and
an aluminum-containing species in an amount of up to 20 wt. %, based on the total weight of the composition.

Embodiment 87. The composition of Embodiment 86, wherein the aluminum-containing species comprises Al(OH)₃.

Embodiment 88. The composition of Embodiment 87, wherein the aluminum-containing species comprises a species of Formula I or Formula II:

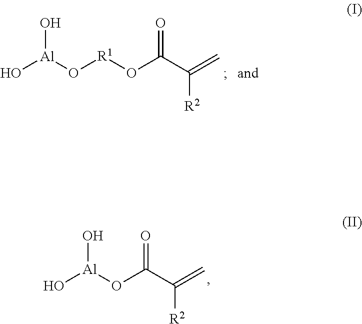

wherein R¹ is C1-C10 alkyl or alkylene (e.g., CH₂) and R² is H or CH₃.

Embodiment 89. The composition of Embodiment 86, wherein the aluminum-containing species comprises Al₂O₃.

Embodiment 90. The composition of Embodiment 89, wherein the Al₂O₃ is functionalized with one or more polymerizable groups.

Embodiment 92. The composition of any of Embodiments 86-90, further comprising an organophosphorus component comprising one or more organophosphorus compounds.

Embodiment 93. The composition of Embodiment 92, wherein the one or more organophosphorous compound comprises one or more organophosphate compounds.

Embodiment 94. The composition of Embodiment 93, wherein the one or more organophosphate compounds are of Formula (XI):

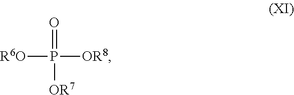

wherein R⁶-R⁸ are independently selected from the group consisting of hydrogen, alkyl, alkenyl, alkynyl, cycloalkyl, heteroalkyl, heteroalkenyl, heterocyclyl, aryl, heteroaryl, and (meth)acryloyl.

Embodiment 95. The composition of Embodiment 93, wherein the one or more organophosphate compounds comprise bis(organophosphate).

Embodiment 96. The composition of Embodiment 92, wherein the one or more organophosphorus compounds comprises a phosphinate component.

Embodiment 97. The composition of Embodiment 96, wherein the phosphinate component comprises a species of Formula XII or Formula XIII:

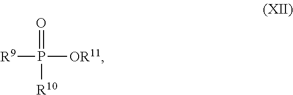

wherein R⁹, R¹⁰, and R¹¹ are each independently selected from the group consisting of hydrogen, alkyl, alkenyl, alkynyl, cycloalkyl, heteroalkyl, heteroalkenyl, heterocyclyl, aryl, and heteroaryl; and

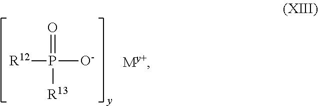

wherein R¹² and R¹³ are each independently selected from the group consisting of hydrogen, alkyl, alkenyl, alkynyl, cycloalkyl, heteroalkyl, heteroalkenyl, heterocyclyl, aryl, and heteroaryl; M is a metal; and
y is an integer ranging from 1 to 3.

Embodiment 98. The composition of Embodiment 93, wherein the one or more organophosphate compounds comprises a urethane (meth)acrylate moiety.

Embodiment 99. The composition of Embodiment 92, wherein the one or more organophosphorus compounds comprises a phosphonate.

Embodiment 100. The composition of Embodiment 99, wherein the phosphonate comprises a species of Formula XIV or Formula XV:

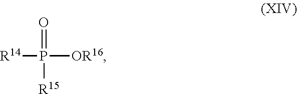

wherein R¹⁴, R¹⁵, and R¹⁶ are each independently selected from the group consisting of hydrogen, alkyl, alkenyl, alkynyl, cycloalkyl, heteroalkyl, heteroalkenyl, heterocyclyl, aryl, and heteroaryl; and

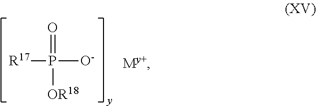

wherein R¹⁷ and R¹⁸ are each independently selected from the group consisting of hydrogen, alkyl, alkenyl, alkynyl, cycloalkyl, heteroalkyl, heteroalkenyl, heterocyclyl, aryl, and heteroaryl; M is a metal; and
y is an integer ranging from 1 to 3.

Embodiment 101. The composition of Embodiment 99, wherein the phosphonate comprises a species of Formula IX:

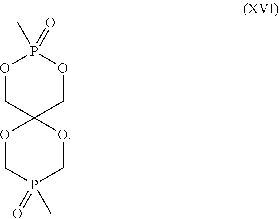

Embodiment 102. The composition of Embodiment 92, wherein the one or more organophosphorus compounds comprises a species of Formula XVI:

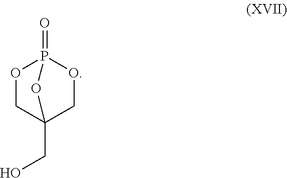

Embodiment 103. The composition of any of Embodiments 92-102, wherein the organophosphorous component is present in an amount of 10-40 wt. %, based on total weight of the composition.

Embodiment 104. The composition of any of Embodiments 86-103, further comprising a heptazine or melamine-derived component.

Embodiment 105. The composition of Embodiment 104, wherein the heptazine or melamine-derived component comprises a species of Formula XXI:

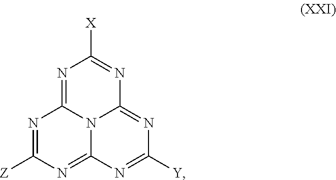

wherein X, Y, and Z are each independently selected from H and NR²⁷R²⁸,
wherein R²⁷ and R²⁸ are each independently selected from H and a C1-C5 alkyl.

Embodiment 106. The composition of Embodiment 104, wherein the heptazine or melamine-derived component comprises a species of Formula XXII:

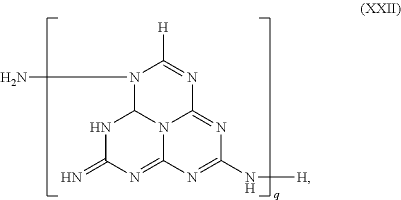

wherein q is an integer from 2 to 1000.

Embodiment 107. The composition of Embodiment 104, wherein the heptazine or melamine-derived component comprises a species of Formula XXIII:

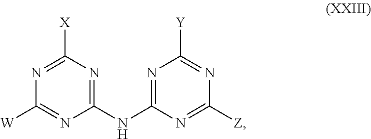

wherein W, X, Y, and Z are each independently selected from H and NR²⁷R²⁸.
wherein R²⁷ and R²⁸ are each independently selected from H and a C1-C5 alkyl.

Embodiment 108. The composition of claim 104, wherein the heptazine or melamine-derived component comprises a heptazine or melamine-derived oligomer.

Embodiment 109. The composition of Embodiment 108, wherein the heptazine or melamine-derived component comprises g-C₃N₄.

Embodiment 110. The composition of Embodiment 104, wherein the heptazine or melamine-derived component does not comprise melamine.

Embodiment 111. The composition of any of Embodiments 86-110, further comprising a polymeric organobromine component.

Embodiment 112. The composition of Embodiment 111, wherein the polymeric organobromine component comprises a brominated polystyrene, a brominated polyacrylate, a brominated epoxy, an end-capped brominated epoxy, or a combination of two or more of the foregoing.

Embodiment 113. The composition of any of Embodiments 86-112, further comprising an expandable graphite component.

Embodiment 114. The composition of any of Embodiments 86-92, 96, 97, and 99-113, wherein the composition is free or substantially free of phosphate.

Embodiment 115. The composition of any of Embodiments 86-114, wherein the thermoplastic polymer comprises an acrylonitrile butadiene styrene (ABS), a polylactic acid (PLA), a polyethylene terephthalate (PET), a thermoplastic polyurethane (TPU), a nylon, a polycarbonate, or a combination, block copolymer, or melt of two or more of the foregoing.

Embodiment 116. The composition of any of Embodiments 86-115, wherein the composition, when solidified, passes FAR 25.853 (60 second and 12 second), and has a Tensile Strength (TS) Ratio of at least 1.0.

Embodiment 117. A method of printing a three-dimensional article comprising:
providing the composition of any of Embodiments 86-116; and
selectively solidifying layers of the composition to form the article.

Embodiment 118. The method of Embodiment 117, wherein the composition is provided in a layer-by-layer process.

Embodiment 119. The method of Embodiment 117 or Embodiment 118, wherein:
the article passes FAR 25.853 (60 second and 12 second); and
the article has a Tensile Strength (TS) Ratio of at least 1.0.

Embodiment 120. The method of Embodiment 119, wherein the article has a Tensile Strength (TS) Ratio of greater than 1.0.

Embodiment 121. The method of any of Embodiments 117-120, wherein the article has a limiting oxygen index of 25-30% according to ISO 4589.

Embodiment 122. The method of Embodiment 121, wherein the article has a limiting oxygen index of 28-30% according to ISO 4589.

Embodiment 123. The method of any of Embodiments 117-122, wherein the article has a v0 rating according to UL 94V.

Embodiment 124. The method of any of Embodiments 117-122, wherein the article has a v1 rating according to UL 94V.

All patent documents referred to herein are incorporated by reference in their entireties. Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A composition for additive manufacturing comprising:
an aluminum-containing species in an amount of up to 20 wt. %, based on the total weight of the composition.

2. The composition of claim 1, wherein the aluminum-containing species comprises Al(OH)₃.

3. The composition of claim 1, wherein the aluminum-containing species comprises a species of Formula I or Formula II: 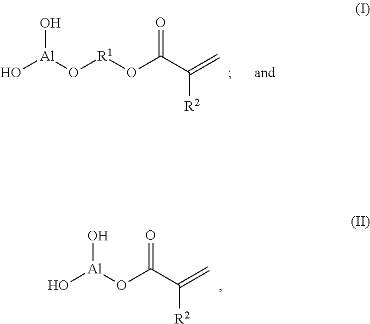
wherein R¹ is C1-C10 alkyl and R² is H or CH₃.

4. The composition of claim 1, wherein the aluminum-containing species comprises Al₂O₃.

5. The composition of claim 4, wherein the Al₂O₃ is functionalized with one or more polymerizable groups.

6. The composition of claim 1 further comprising a polymerizable component.

7. The composition of claim 6, wherein the polymerizable component is a (meth)acrylate component.

8. The composition of claim 7, wherein the (meth)acrylate component is present in an amount of 30-70 wt. %, based on total weight of the composition.

9. The composition of claim 7, wherein the (meth)acrylate component comprises a mixture of (meth)acrylate monomer and (meth)acrylate oligomer.

10. The composition of claim 6, wherein the polymerizable component is a curable isocyanurate component.

11. The composition of claim 10, wherein the curable isocyanurate component comprises isocyanurate polyacrylate, polyallyl isocyanurate, or a mixture thereof.

12. The composition of claim 11, wherein the curable isocyanurate comprises isocyanurate polyacrylate, and the isocyanurate polyacrylate is of Formula IX: 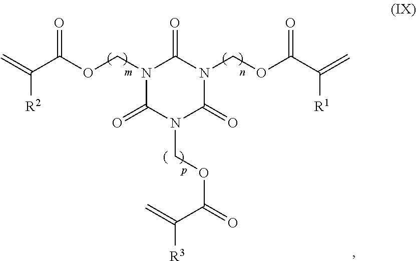
wherein R³-R⁵ are each independently selected from the group consisting of hydrogen and alkyl and m, n, and p are each integers independently ranging from 1 to 10.

13. The composition of claim 11, wherein the curable isocyanurate comprises polyallyl isocyanurate, and the polyallyl isocyanurate is of Formula X: 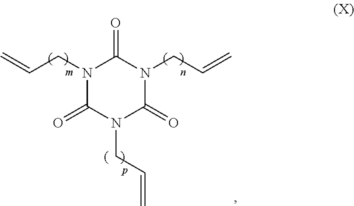
wherein m, n, and p are integers independently ranging from 1 to 10.

14. The composition of claim 10, wherein the curable isocyanurate component is present in an amount of 30-80 wt. %, based on total weight of the composition.

15. The composition of claim 1, wherein the composition further comprises an organophosphorus component comprising one or more organophosphorus compounds.

16. The composition of claim 15, wherein the one or more organophosphorous compounds comprises an organophosphate, a phosphinate, or a phosphonate.

17. The composition of claim 1 further comprising a brominated acrylate ester component.

18. The composition of claim 1 further comprising an additive of Formula XX: 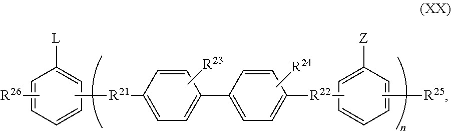
wherein L and Z are ring substituents comprising at least one polymerizable point of unsaturation, and wherein R²¹ and R²² are alkylene, and R²³-R²⁶ each represent one to four optional ring substituents, each one of the one to four ring substituents independently selected from the group consisting of alkyl, heteroalkyl, haloalkyl, halo, hydroxyl, alkoxy, amine, amide, and ether, and wherein x is an integer from 1 to 7.

19. A method of printing a three-dimensional article comprising:
providing the composition of claim 1; and
selectively curing a portion of the composition,
wherein the composition is provided in a layer-by-layer process, and
wherein curing comprises photocuring.

20. A composition for additive manufacturing comprising:
a sinterable powder in an amount of 10-99 wt. %, based on the total weight of the composition; and
an aluminum-containing species in an amount of up to 20 wt. %, based on the total weight of the composition,
wherein the aluminum-containing species comprises Al(OH)₃.
